(19) United States
(12) Patent Application Publication
(10) Pub. No.: US 2017/0006306 A1
(43) Pub. Date: Jan. 5, 2017

(54) MOVING IMAGE DECODING METHOD, MOVING IMAGE ENCODING METHOD, AND MOVING IMAGE DECODING APPARATUS

(71) Applicant: FUJITSU LIMITED, Kawasaki-shi (JP)

(72) Inventors: Akihiro YAMORI, Kawasaki (JP); Junpei KOYAMA, Shibuya (JP); Satoshi SHIMADA, Kawasaki (JP); Hidenobu MIYOSHI, Kawasaki (JP); Kimihiko KAZUI, Kawasaki (JP)

(73) Assignee: FUJITSU LIMITED, Kawasaki-shi (JP)

(21) Appl. No.: 15/268,720

(22) Filed: Sep. 19, 2016

Related U.S. Application Data
(63) Continuation of application No. 13/960,991, filed on Aug. 7, 2013.
Application No. 13/960,991 is a continuation of application No. PCT/JP2011/056463, filed on Mar. 17, 2011.

(51) Int. Cl. H04N 19/52; H04N 19/91; H04N 19/56

(52) U.S. Cl. CPC H04N 19/52; H04N 19/56; H04N 19/91

(57) ABSTRACT

A moving image decoding method for decoding encoded data of an image partitioned into a plurality of blocks includes determining a predicted motion vector corresponding to a motion vector of a block to be decoded by using motion vector information, the motion vector information including a motion vector of an already-decoded block and reference destination information designating a reference destination of the motion vector of the already-decoded block; controlling a decoding process of the motion vector of the block to be decoded using the predicted motion vector depending on whether the reference destination information designating the reference destination of the motion vector designates an inter-view reference image; and decoding the motion vector of the block to be decoded with the controlled decoding process.

### CROSS-REFERENCE TO RELATED APPLICATIONS

This application is a continuation application of U.S. Ser. No. 13/960,991 filed on Aug. 7, 2013, which is a continuation of International Application PCT/JP2011/056463 filed on Mar. 17, 2011 and designated the U.S., the entire contents of which are incorporated herein by reference.

### FIELD

The disclosures herein relate to a moving image decoding method, a moving image encoding method, and a moving image decoding apparatus that process multi-view video.

### BACKGROUND

In moving image encoding methods, high compression is realized by reducing difference information using motion prediction, and applying frequency transform to the difference information for obtaining fewer effective coefficients with low frequencies.

Moving image encoding is widely used, which includes MPEG-2 (Moving Picture Experts Group), MPEG-4, and H.264/AVC (H.264/MPEG-4 Advanced Video Coding) that have been defined at ISO/IEC (International Standardization Organization/International Electrotechnical Commission).

H.264 is a name defined at ITU-T (International Telecommunication Union Telecommunication Standardization Sector) that defines international standards for communication.

Also, as next-generation encoding, encoding called HEVC (High Efficiency Video Coding) has been promoted.

In a moving image encoding method, frequency-transformed difference information has variable-length encoding applied. On the other hand, also for a motion vector, motion vector components themselves are not encoded, but difference vectors with motion vectors of surrounding blocks are encoding to realize reduction of the encoding amount of the motion vector.

For example, in H.264 encoding, a predicted motion vector, which calculates a difference with a motion vector, is obtained as follows. FIG. 1 is a schematic view illustrating an example of a current block to be encoded and surrounding blocks. The current block to be encoded is also called the current block bCurr. In the example illustrated in FIG. 1, surrounding blocks are a block bA (left block), a block bB (upper block), and a block bC (upper right block). The blocks are, for example, macro blocks.

Among vectors of the surrounding blocks, a predicted motion vector (PMV) is to be obtained for calculating a difference vector with the motion vector of the current block. The predicted motion vector is, specifically, composed of horizontal/vertical components that are intermediate values of the surrounding vectors.

Here, suppose that the motion vector of the block bA is VbA=(VbAx, VbAy), the motion vector of the block bB is VbB=(VbBx, VbBy), and the motion vector of the block bC is VbC=(VbCx, VbCy). Then, the predicted motion vector is calculated by the following formulae:

PMVx=median(VbAx,VbBx,VbCx) formula (1)

PMVy=median(VbAy,VbBy,VbCy) formula (2)

PMV=(PMVx, PMVy): predicted motion vector
where median( ) selects an intermediate value in arguments.

If the block bA is partitioned, the vector of the uppermost subblock among the partitioned subblocks is used as VbA. If the block bB is partitioned, the vector of the leftmost subblock among the partitioned subblocks is used as VbB.

Also, exceptional handling is defined in H.264 as follows:

(1) If the block bA, bB, or bC cannot be referenced due to out of screen or out of slice, the block becomes invalid. However, if the block at pos C is out of screen at the rightmost end of the screen, the block bD (upper left block) is referenced.
(2) If there is only one motion vector among VbA, VbB, VbC that has the same reference destination picture as the motion vector VbCurr of the current block bCurr of the current picture, PMV is set to VbX where X is the block that has the same reference destination picture. A picture including a current block is also called a current picture.
(3) If the current block bCurr is vertically partitioned, the PMV of the left VbCurr is set to VbA and the PMV of the right VbCurr is set to VbC. Also, if the current block bCurr is horizontally partitioned, the PMV of the upper VbCurr is set to VbB and the PMV of the lower VbCurr is set to VbC.

Also, in HEVC, an encoding method of motion vectors called Competition-based scheme for motion vector selection and coding (referred to as MV Competition, hereafter) is proposed, with which a selection method of surrounding vectors becomes more flexible.

In MV Competition, a mechanism is introduced that make it possible to explicitly indicate information about blocks usable for the predicted motion vector or the like, along with the position of a block to be decoded.

FIG. 2 is a schematic view illustrating a definition of surrounding blocks in HEVC. In the example illustrated in FIG. 2, a predicted motion vector can be determined using not only the motion vectors of surrounding blocks bA, bB, and bC of a current picture where a current block bCurr exists, but also the motion vectors of blocks colMB and c0 to c7 of a different picture colPic that has already been processed. The block colMB is the block in the picture colPic that has the same position as the current block bCurr in CurrPic.

In an encoding method newer than H.264, refPicList is provided for each picture because multiple references are allowed for directions to be referenced. The refPicList is provided for each picture by assigning an index number to the list of the pictures that have references.

A predicted motion vector is sent explicitly with an index pmvIdx (the identifier for a predicted motion vector). A concrete example is as follows. In the example illustrated in FIG. 2, among the surrounding blocks of the current picture CurrPic, the blocks bA, bB, bC, and bD adjacent at left, upper, upper right, and upper-left, respectively, are surrounding blocks as defined in H.264.

Motion vectors of the reference blocks bA, bB, bC, and bD are denoted as VbA, VbB, VbC, and VbD, respectively.

Moreover, in an immediately preceding non-reference processed picture colPic, surrounding blocks are defined including the block colMB at the same position as the current block bCurr in CurrPic and its surrounding blocks c0 to c7.

The motion vectors of the block colMB and all of its surrounding blocks ci (i=0, 1, . . . , 7) are denoted as Vcol and Vci.

If all reference blocks can be referenced, the index pmvIdx can be represented with, for example, a 4-bit value ranging from “0” to “9”. Depending on the value of the index pmvIdx, the predicted motion vector is defined as follows:

pmvIdx=0: PMV=median (VbA, VbB, VbC)

pmvIdx=1: PMV=VbA

pmvIdx=2: PMV=VbB

pmvIdx=3: PMV=VbC

pmvIdx=4: PMV=VbD

pmvIdx=5: PMV=VspaEXT

pmvIdx=6: PMV=Vcol

pmvIdx=7: PMV=med (Vcol,Vc0,Vc1,Vc2,Vc3)

pmvIdx=8:

### PMV=med(Vcol,Vc0,Vc1,Vc2,Vc3,Vc4,Vc5,Vc6,Vc7)

pmvIdx=9: PMV=med (Vcol,Vcol,VbA,VbB,VbC)

where function median (Vj), Vj is included in {VbA,VbB,VbC,Vcol,Vci}, outputs the median of horizontal direction components of motion vectors Vj, which are arguments of the function, and the median of vertical direction components, where the medians are output independently from each other.

Also, if one of the arguments of function median (Vj) is undefined, output values of function median (Vj) are not defined.

Also, a definition of VspaEXT is as follows.

$$\begin{matrix}Vspa EXT = med ( VbA , VbB , VbC ) \text{:} if all blocks are valid . \\ = VbA \text{:} if bA is valid , and bB or bC is not valid . \\ = VbB \text{:} if bB is valid , and bA is not valid . \\ = VbC \text{:} otherwise\end{matrix}$$

Validity of a reference block is determined based on whether the reference block can be referenced, exists in refPicList, and is inter-encoded using a motion vector.

Also, the definition for cases where PMV of an index is not valid is as follows:

A reference block that is not valid is bA:VbA=(0,0)
A reference block that is not valid is bB:VbB=VbA
A reference block that is not valid is bC:VbC=VbA
A reference block that is not valid is bD:VbD=VbA
A reference block that is not valid is colMB: Vcol is undefined
A reference block that is not valid is ci (i=0, 1, . . . , 7):Vci=Vcol

The value of an index pmvIdx corresponding to an undefined motion vector is also undefined. Moreover, if there exist multiple values of indices pmvIdx that correspond to the same predicted motion vector, the values other than the minimum value can be removed. In this case, the value of index pmvIdx may be reassigned.

To avoid increase of a processing amount and a bandwidth due to increase of reference blocks, indices may be restricted and implemented as follows:

pmvIdx=0: PMV=median (VbA,VbB,VbC)
pmvIdx=1: PMV=VbA
pmvIdx=2: PMV=VbB
pmvIdx=3: PMV=VbC
pmvIdx=4: PMV=Vcol

Here, an index pmvIdx with a smaller number is assigned a shorter code with variable-length coding.

Also, if there are multiple surrounding blocks for a case where a current block is large, such as the size of 64×64, the uppermost block among left-adjacent blocks is set to bA and the leftmost block among upper-adjacent blocks is set to bB to generate a predicted motion vector.

Also, in recent years, video encoding with multiple viewpoints such as MVC (Multi-view Video Coding) and the like have been put into practical use. In MVC, there exists a base-view in which encoding/decoding is executed without using other view information and a non-base-view in which other view information can be used for prediction. Also, there exists intra-view prediction in which motion prediction is executed in time direction as executed in conventional encoding, and inter-view prediction in which motion prediction is executed with images from other views at the same time. Inter-view prediction executes a cross-view prediction at the same moment. Identification information of a picture is represented by POC (Picture Order Count), hence pictures at the same time have the same POC.

For example, as a technology for encoding a multi-view video, there is a technology that uses a high-level syntax to perform inter-view prediction of a block.

### RELATED-ART DOCUMENTS

### Patent Documents

[Patent Document 1] Japanese Laid-open Patent Publication No. 2009-522985

Here, considering inter-view prediction, to present video as if it popped out from a screen, left and right images are shifted in the same horizontal direction as in the direction of left and right human eyes are shifted. The horizontally shifted moving images comprise left and right views. Therefore, considering shifting in left and right directions, motion vectors in inter-view prediction are motion vectors oriented in horizontal directions in most cases.

If inter-view prediction is allowed for an image, intra-view prediction and inter-view prediction coexist for blocks of the image. FIG. 3 is a schematic view illustrating examples of motion vectors of blocks.

Assume that blocks 11 illustrated in FIG. 3 are blocks applied with inter-view prediction and blocks 12 are blocks applied with intra-view prediction. Assume also that motion vectors 13 represent inter-view motion vectors and motion vectors 14 represent intra-view motion vectors. The motion vectors 14 reference blocks in forward direction or backward direction.

In this case, it can be said that there exists the following tendency with the motion vectors.

Intra-view prediction: the motion vectors 14 are oriented in directions following motions in the video.
Inter-view prediction: the motion vectors 13 are oriented in horizontal directions following small motions (disparities in the multi-view video).

When encoding a motion vector, for example, a difference vector with a predicted motion vector that represents surrounding blocks is encoded. However, in multi-view video encoding that allows inter-view prediction, the motion vectors 14 referencing intra-view blocks and the motion vectors 13 referencing inter-view blocks coexist as illustrated in FIG. 3.

Here, attention is paid to the vertical components of the vectors. If the reference destination of the motion vector and the reference destination of the predicted motion vector in a current block are different with respect to intra-view and inter-view, the vertical component of the motion vector for inter-view prediction is almost zero whereas the vertical component of the motion vector for intra-view prediction is non-zero depending on a movement of screen.

In this case, the vertical component of the difference vector tends to take a great value. Consequently, the encoding amount of the vertical component of the motion vector becomes great. Therefore, conventional multi-view video encoding methods cannot efficiently perform encoding/decoding of a motion vector.

### SUMMARY

According to an aspect of the disclosure, a moving image decoding method for decoding encoded data of an image partitioned into a plurality of blocks includes: determining a predicted motion vector corresponding to a motion vector of a block to be decoded by using motion vector information, the motion vector information including a motion vector of an already-decoded block and reference destination information designating a reference destination of the motion vector of the already-decoded block; controlling a decoding process of the motion vector of the block to be decoded using the predicted motion vector depending on whether the reference destination information designating the reference destination of the motion vector designates an inter-view reference image; and decoding the motion vector of the block to be decoded with the controlled decoding process.

Also, according to another aspect of the disclosure, a moving image encoding method for encoding data of an image partitioned into a plurality of blocks, includes: determining a predicted motion vector corresponding to a motion vector of a block to be encoded by using motion vector information, the motion vector information including a motion vector of an already-encoded block and reference destination information designating a reference destination of the motion vector of the already-encoded block; controlling an encoding process of the motion vector of the block to be encoded using the predicted motion vector depending on whether the reference destination information designating the reference destination of the motion vector designates an inter-view reference image; and encoding the motion vector of the block to be encoded with the controlled encoding process.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a current block to be encoded and surrounding blocks;

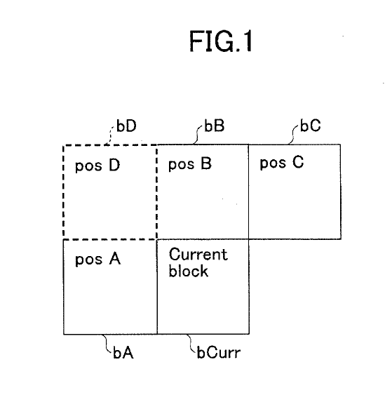

FIG. 2 is a schematic view illustrating a definition of surrounding blocks in HEVC;

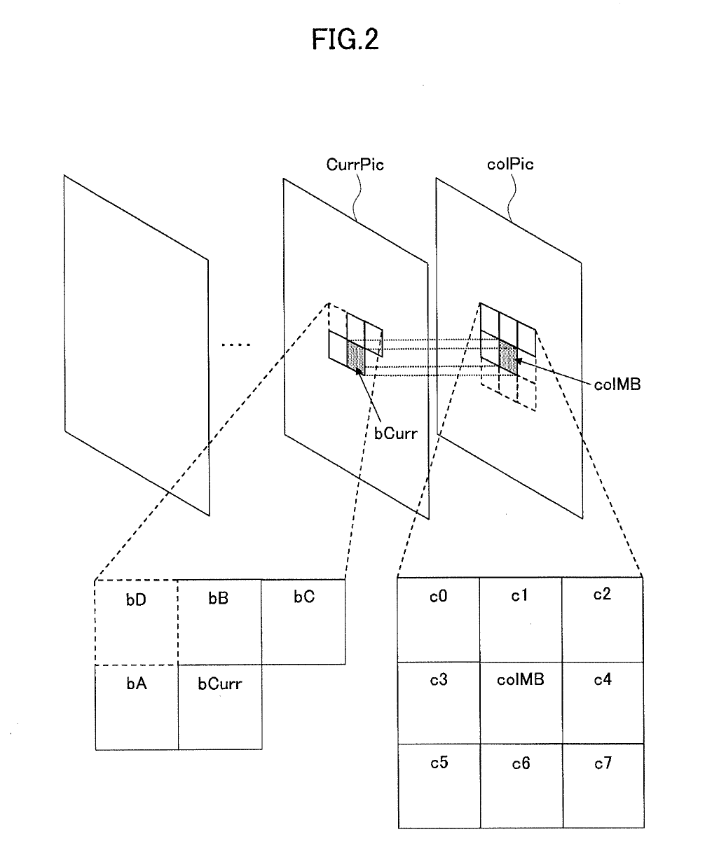

FIG. 3 is a schematic view illustrating examples of motion vectors of blocks;

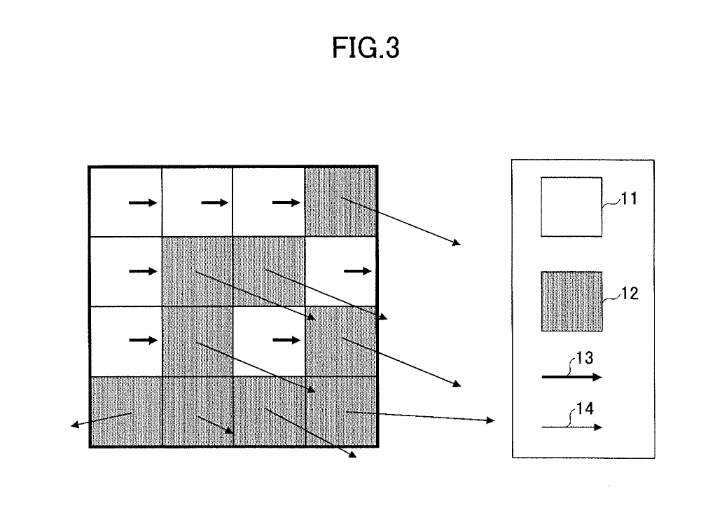

FIG. 4 is a block diagram illustrating an example of a configuration of a moving image encoding apparatus according to a first embodiment;

FIG. 5 is a schematic view illustrating a relationship between motion vectors with respect to intra-view prediction and inter-view prediction;

FIG. 6 is a flowchart illustrating a moving image encoding process according to the first embodiment;

FIG. 7 is a block diagram illustrating an example of a configuration of a moving image decoding apparatus according to a second embodiment;

FIG. 8 is a flowchart illustrating a moving image decoding process according to the second embodiment;

FIG. 9 is a block diagram illustrating an example of a configuration of a moving image encoding apparatus according to a third embodiment;

FIG. 10 is an element table illustrating context models for CABAC according to H.264;

FIG. 11 is a schematic view illustrating a first element table of a context model according to the third embodiment;

FIG. 12 is a schematic view illustrating a second element table of a context model according to the third embodiment;

FIG. 13 is a flowchart illustrating a moving image encoding process according to the third embodiment;

FIG. 14 is a block diagram illustrating an example of a configuration of a moving image decoding apparatus according to a fourth embodiment;

FIG. 15 is a flowchart illustrating a moving image decoding process according to the fourth embodiment;

FIG. 16 is a block diagram illustrating an example of a configuration of a moving image encoding apparatus according to a fifth embodiment;

FIG. 17 is a flowchart illustrating a first moving image encoding process according to the fifth embodiment;

FIG. 18 is a flowchart illustrating a second moving image encoding process according to the fifth embodiment;

FIG. 19 is a flowchart illustrating a calculation process of A according to the fifth embodiment;

FIG. 20 is a block diagram illustrating a configuration of a moving image decoding apparatus 600 according to a sixth embodiment;

FIG. 21 is a flowchart illustrating a moving image decoding process according to the sixth embodiment;

FIG. 22 is a schematic view illustrating problems in MV Competition in HEVC;

FIG. 23 is a schematic view illustrating block names, referenced positions, and motion vectors of blocks;

FIG. 24 is a flowchart illustrating a moving image encoding process according to a seventh embodiment;

FIG. 25 is a flowchart illustrating a moving image encoding process according to an eight embodiment; and

FIG. 26 is a block diagram illustrating an example of a configuration of an image processing apparatus.

### DESCRIPTION OF EMBODIMENTS

According to the disclosed technology, it is possible to efficiently perform encoding/decoding of a motion vector for a multi-view video.

First, according to the following embodiments, encoding/decoding of a difference vector is controlled depending on a relationship between a reference destination of a motion vector of a block to be encoded/decoded (also referred to as a current block) and reference destinations of motion vectors of surrounding blocks. This reduces an encoding amount of the motion vector, which makes encoding/decoding of the motion vector efficient. In the following, embodiments will be described in detail with reference to the drawings.

### First Embodiment

### Configuration

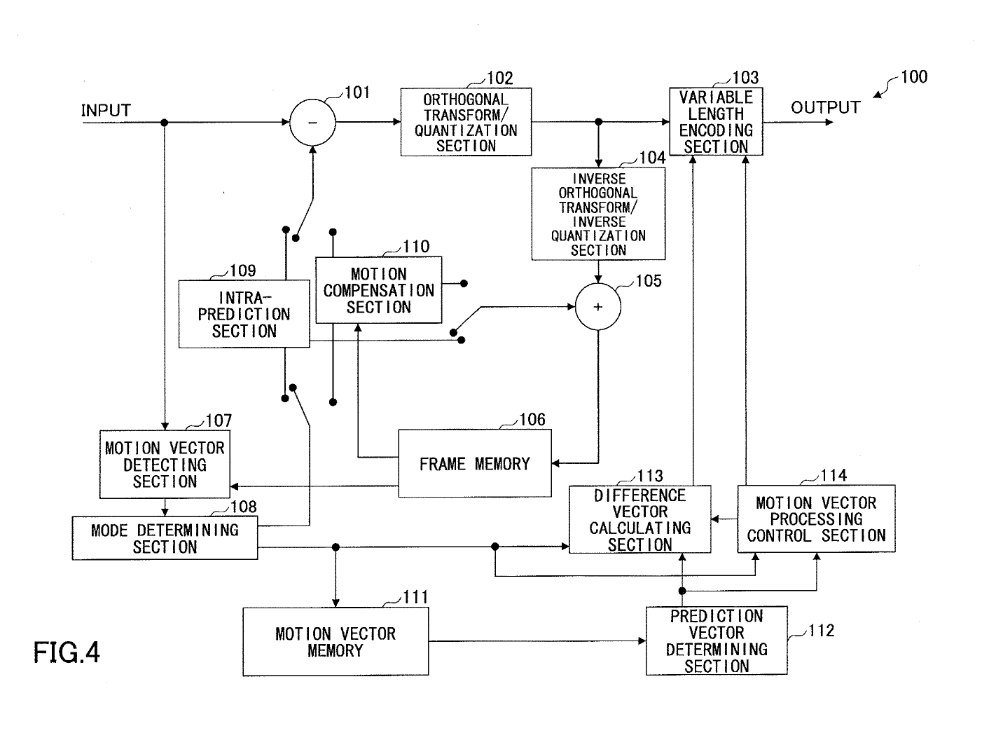

FIG. 4 is a block diagram illustrating an example of a configuration of a moving image encoding apparatus 100 according to the first embodiment. The moving image encoding apparatus 100 illustrated in FIG. 4 includes a predicted error difference generating section 101, an orthogonal transform/quantization section 102, a variable-length encoding section 103, an inverse orthogonal transform/inverse quantization section 104, a decoded image generating section 105, and a frame memory 106. The moving image encoding apparatus 100 also includes a motion vector detecting section 107, a mode determining section 108, an intra-prediction section 109, a motion compensation section 110, a motion vector memory 111, a predicted motion vector determining section 112, a difference vector calculating section 113, and a motion vector processing control section 114.

The moving image encoding apparatus 100 illustrated in FIG. 4 illustrates a configuration for encoding non-base-view moving images. Among the sections above, sections other than the motion vector processing control section 114 are also to be provided for encoding base-view moving images, but they are omitted here to avoid duplicated description. This is also applicable to moving image encoding apparatuses that will be described later.

A process for encoding a non-base-view moving image will be described. The predicted error difference generating section 101 obtains macro block data (also referred to as MB data, hereafter), which is block data obtained by partitioning an input image to be encoded into 16×16-pixel blocks (MB).

The predicted error difference generating section 101 calculates difference between the MB data and MB data of a predicted image output by the intra-prediction section 109 or the motion compensation section 110 to generate predicted error difference data. The predicted error difference generating section 101 outputs the generated predicted error difference data to the orthogonal transform/quantization section 102.

The orthogonal transform/quantization section 102 applies an orthogonal transform to the input predicted error difference data with 8×8 units or 4×4 units. The orthogonal transform may be DCT (Discrete Cosine Transform), Hadamard transform, or the like. The orthogonal transform/quantization section 102 obtains data separated into horizontal and vertical frequency components by the orthogonal transform.

The orthogonal transform is applied because it is possible to compress an amount of information by transforming image data into frequency components, in which low frequency components become dominant due to a spatial correlation of an image.

The orthogonal transform/quantization section 102 quantizes the orthogonal-transformed data to reduce an encoding amount of the data, then outputs the quantized values to the variable-length encoding section 103 and the inverse orthogonal transform/inverse quantization section 104.

The variable-length encoding section 103 applies variable-length encoding to the data output from the orthogonal transform/quantization section 102 to output the encoded data. Variable length encoding is an encoding method that assigns variable-length codes to symbols based on appearance frequencies of the symbols.

The variable-length encoding section 103 basically assigns a shorter code to a combination of coefficients that has a high appearance frequency and a longer code to a combination of coefficients that has a low appearance frequency, for example, This makes the total encoding length shorter. In H.264, it is possible to select a variable-length coding method called CAVLC (Context-Adaptive Variable Length Coding) or CABAC (Context-Adaptive Binary Arithmetic Coding).

The variable-length encoding section 103 may be controlled by the motion vector processing control section 114 for an encoding process, for example, of motion vectors.

The inverse orthogonal transform/inverse quantization section 104 applies inverse quantization to the data output from the orthogonal transform/quantization section 102 for applying inverse orthogonal transform. The inverse orthogonal transform/inverse quantization section 104 transforms frequency components into pixel components with the inverse orthogonal transform to output the transformed data to the decoded image generating section 105. By decoding with the inverse orthogonal transform/inverse quantization section 104, a signal can be obtained that is similar to a predicted error difference signal before encoding.

The decoded image generating section 105 adds the predicted error difference data decoded by the inverse orthogonal transform/inverse quantization section 104 to data output from the intra-prediction section 109 or MB data of an image applied with motion compensation by the motion compensation section 110. This makes it possible to generate substantially the same processed image at the encoding side as at a decoding side.

An image generated at the encoding side is called a locally decoded image. By generating substantially the same processed image at the encoding side as at a decoding side, it is possible to perform difference encoding with the next picture and after. The decoded image generating section 105 outputs the generated MB data of the locally decoded image obtained with the addition to the frame memory 106. Here, the MB data of the locally decoded image may be applied with a deblocking filter. The locally decoded image can be used as a reference image.

The frame memory 106 stores the input MB data as new reference image data. The reference image is read out by the motion compensation section 110, or the motion vector detecting section 107. The frame memory 106 may store reference images of other views.

The motion vector detecting section 107 executes motion search using MB data of an image to be encoded and MB data of an encoded reference image obtained from the frame memory 106 to obtain an appropriate motion vector.

A motion vector comprises component values representing spatial shift for a block that is obtained by using a block matching technology to search for a position of the block in the reference image that is most analogous to the image to be encoded.

Motion search is generally executed by adding, for example, not only the magnitude of the sum of absolute differences of values of pixels, but also an evaluation value of a motion vector. When encoding a motion vector, the components themselves are not encoded, but a difference vector with a motion vector of a surrounding MB is encoded. Therefore, the motion vector detecting section 107 calculates a difference vector, and based on its magnitude, outputs an evaluation value corresponding to the encoding length of the motion vector.

If the evaluation value of the motion vector is represented by “cost”, the sum of absolute differences of values is represented by SAD(Sum of Absolute Differences)_cost, and the evaluation value corresponding to encoding length of the motion vector is represented by MV(Motion Vector)_cost, the motion vector detecting section 107 detects a position of the motion vector that gives a minimum cost by the following formula.

cost=SAD_cost+MV_cost

The motion vector detecting section 107 outputs the detected motion vector to the mode determining section 108.

Here, if the motion vector detecting section 107 can use reference images of other views, a block matching is executed for a block of a reference image obtained from the frame memory storing locally decoded images of other views.

The mode determining section 108 selects an encoding mode that has the lowest encoding cost among the following five encoding modes. An encoding mode is also referred to as a prediction mode. The mode determining section 108 selects optimal prediction modes for cases, for example, for a case where motion prediction is executed with a direct vector and for a case where usual motion vector prediction is executed (forward direction, backward direction, bidirection, and intra).

Specifically, the mode determining section 108 calculates the following evaluation values for prediction modes.

cost_direct=SAD(*org,*ref);

cost_forward=SAD(*org,*ref)+MV_COST(*mv,*prevmv);

cost_backward=SAD(*org,*ref)+MV_COST(*mv,*prevmv);

cost_bidirection=SAD(*org,*ref)+MV_COST(*mv,*prevmv);

cost_intra=ACT(*org);

Here, the mode determining section 108 calculates the sum of absolute differences of values of pixels in an MB with SAD ( ), in this case, the sum of absolute differences of values for an original image MB (*org) and a reference image MB (*ref) with 16×16 pixels is calculated with the following formula.

SAD( )=Σ|*org−*ref|

Also, as for the direct mode, an already encoded motion vector used when encoding an MB having the same position in colPic is read out from the motion vector memory 111 as a reference vector. The direct mode is a mode in which motion prediction is executed by calculating a direct vector from the read-out reference vector. Therefore, the direct mode is a mode that may not need to send information about a motion vector.

In H.264 encoding or the like, an MB may be partitioned into multiple subblocks. In such a case, for example, if an MB is partitioned into four 8×8 subblocks, a set of four sums of absolute differences of values for 8×8=64 pixels are the SAD evaluation values. Here, subblocks may have various sizes other than 16×16 or 8×8, such as 8×16, 16×8, 4×8, 8×4, or 4×4.

For an intra-MB, an original image itself is encoded instead of a difference image, hence a different evaluation value called an activity is used. For intra-encoding, orthogonal transform is applied to an original image MB itself. Therefore, ACT ( ) is calculated with distances of pixels from the average value of an MB (=AveMB) or the like, by the following formula.

ACT( )=Σ|*org−AveMB|

MV_COST is an evaluation value proportionate to the encoding amount of a motion vector. Encoding of a motion vector (*mv) is not performed with the components of itself, but with a difference vector with a predicted motion vector (*prevmv) based on surrounding MBs, hence the magnitude of the absolute value determines the evaluation value.

It is commonly practiced to use a weight constant λ for changing a degree of influence by MV_COST on the overall cost evaluation value.

MV_COST=λ×(Table[*mv−*prevmv])

where Table[ ] is a table for converting the magnitude of a difference vector into a value corresponding to an encoding amount.

Here, there are various methods for weighting in practice. For example, two methods below may be used.

cost_direct+=W

(W: weight constant)

With the above formula, an evaluation value may be increased by adding a fixed value W.

cost_direct*=α

(α: weight coefficient)
With the above formula, an evaluation value may be multiplied by α.

The mode determining section 108 calculates a minimum evaluation cost, for example, with the following formula to determine an MB_Type corresponding to the minimum evaluation cost as the MB_Type used for encoding.

min_cost=min(cost_direct,cost_forward,cost_backward,cost_bidirection,cost_intra);

The mode determining section 108 writes the motion vector used for the selected prediction mode into the motion vector memory 111, and indicates the motion vector and the selected encoding mode to the motion compensation section 110. Also, the mode determining section 108 outputs the motion vector and reference destination information representing the reference destination of the motion vector, to the difference vector calculating section 113 and the motion vector processing control section 114.

The intra-prediction section 109 generates a predicted image from already encoded surrounding pixels in the image to be encoded.

The motion compensation section 110 applies motion compensation to reference image data obtained from the frame memory 106 with the motion vector provided by the mode determining section 108. Thus, MB data having motion compensation applied is generated as a reference image (predicted image).

The motion vector memory 111 stores a motion vector used for encoding and reference destination information representing the reference destination of the motion vector. The motion vector memory 111 is, for example, a memory section. A motion vector stored in the motion vector memory 111 is read by the predicted motion vector determining section 112.

The predicted motion vector determining section 112 determines a predicted motion vector, for example, by using a motion vector of an already encoded surrounding block among the blocks surrounding the block to be encoded, with formulas (1)-(2). The predicted motion vector determining section 112 outputs the determined predicted motion vector to the difference vector calculating section 113, and outputs the determined predicted motion vector and the reference destination information to the motion vector processing control section 114.

The difference vector calculating section 113 generates a difference vector by calculating the difference between the motion vector of the block to be encoded and the predicted motion vector. The difference vector calculating section 113 outputs the generated difference vector to the variable-length encoding section 103.

The motion vector processing control section 114 controls to change the encoding process of a motion vector based on the reference destination information of the motion vector of the block to be encoded and/or the reference destination information of the predicted motion vector.

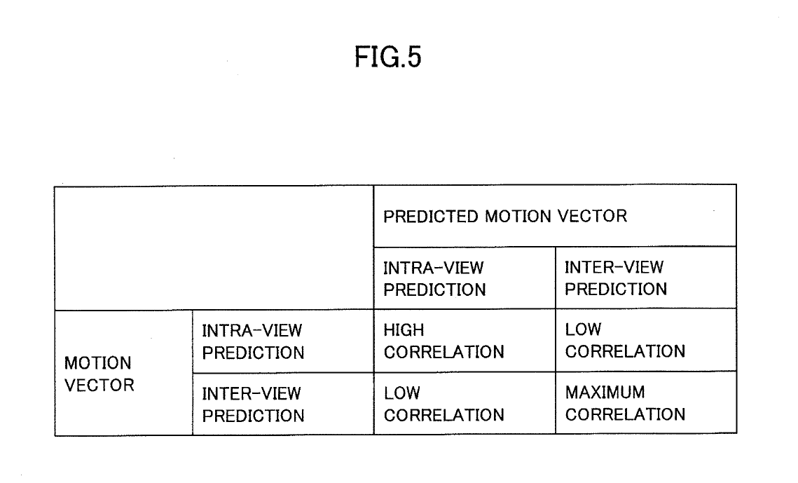

FIG. 5 is a schematic view illustrating a relationship between motion vectors with respect to intra-view prediction and inter-view prediction. As illustrated in FIG. 5, in a block to be decoded, if a motion vector is for inter-view prediction and a predicted motion vector is for inter-view prediction, the correlation of both motion vectors becomes a maximum. This is because there is a high likelihood that both motion vectors have the same disparity vector.

Also, in a block to be decoded, if a motion vector is for intra-view prediction and a predicted motion vector is for intra-view prediction, both motion vectors have a high correlation. This is because there is a possibility that surrounding blocks of the block to be decoded move in the same way as the block to be decoded.

Also, in a block to be decoded, if a motion vector and a predicted motion vector are different with respect to inter-view prediction or intra-view prediction, both motion vectors have a low correlation. This is because a motion vector for inter-view prediction (disparity vector) and a motion vector for intra-view prediction basically differ from each other as described above.

Therefore, the motion vector processing control section 114, as illustrated in FIG. 5, controls the variable-length encoding section 103, the difference vector calculating section 113, or the like so that a motion vector has applied the encoding process suited to a correlation if the motion vector has a certain correlation with the predicted motion vector.

For example, the motion vector processing control section 114 controls to make an encoding process different for a case where both of the reference destination information sets are the same inter-view reference from other cases. Inter-view reference is a case where the reference destination of a motion vector references a block in another view. Intra-view reference is a case where the reference destination of a motion vector references a block in the same view.

<Operations>

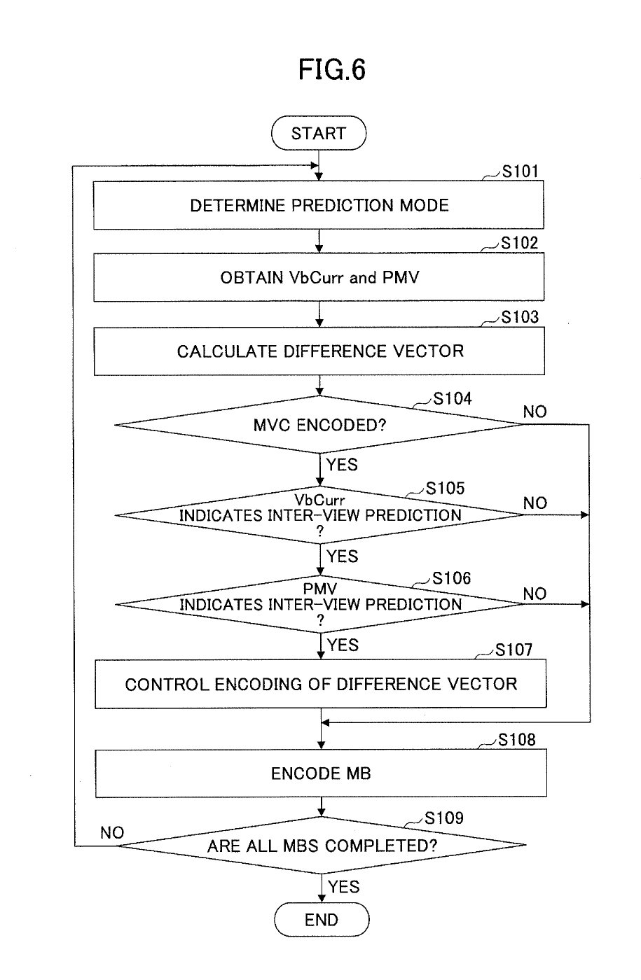

Next, operations of the moving image encoding apparatus 100 will be described according to the first embodiment. FIG. 6 is a flowchart illustrating a moving image encoding process according to the first embodiment.

At Step S101 illustrated in FIG. 6, the mode determining section 108 determines the prediction mode of a block to be encoded. For example, a prediction mode with a minimum encoding cost is selected.

At Step S102, the difference vector calculating section 113 obtains a motion vector VbCurr of the block to be encoded from the mode determining section 108 and a predicted motion vector PMV determined by the predicted motion vector PMV determining section 112.

At Step S103, the difference vector calculating section 113 calculates the difference between the motion vector VbCurr and the predicted motion vector PMV to obtain a difference vector.

At Step S104, the motion vector processing control section 114 determines whether the block to be encoded has had MVC encoding applied. If has been MVC encoding applied (Step S104—YES), Step S105 is taken, or if not applied (Step S104—NO), Step S108 is taken.

At Step S105, the motion vector processing control section 114 determines whether the motion vector VbCurr designates inter-view prediction. Whether designating inter-view prediction can be determined whether the reference destination information of VbCurr designates an intra-view picture or an inter-view picture.

If the motion vector VbCurr designates inter-view prediction (Step S105—YES), Step S106 is taken, or if the motion vector VbCurr does not designate inter-view prediction (Step S105—NO), Step S108 is taken.

At Step S106, the motion vector processing control section 114 determines whether the predicted motion vector PMV designates inter-view prediction. If the predicted motion vector PMV designates inter-view prediction (Step S106—YES), Step S107 is taken, or if the predicted motion vector PMV does not designate inter-view prediction (Step S106—NO), Step S108 is taken.

At Step S107, the motion vector processing control section 114 controls the encoding process of the motion vector.

At Step S108, the variable-length encoding section 103 applies variable-length encoding to the quantization value of the MB. If controlled by the motion vector processing control section 114, the variable-length encoding section 103 applies encoding to the difference vector with the controlled encoding process.

At Step S109, the moving image encoding apparatus 100 determines whether all MBs are completed with the encoding process. If all MBs are completed (Step S109—YES), the encoding process ends, or otherwise (Step S109—NO) the procedure goes back to Step S101.

As above, according to the first embodiment, it is possible to reduce the encoding amount of a motion vector in the encoding process of the motion vector by controlling the encoding process based on the motion vector of a block to be encoded and and/or reference destination information of the predicted motion vector.

### Second Embodiment

Next, a moving image decoding apparatus 200 will be described according to the second embodiment. In the second embodiment, data encoded by the moving image encoding apparatus 100 according to the first embodiment will be decoded.

<Configuration>

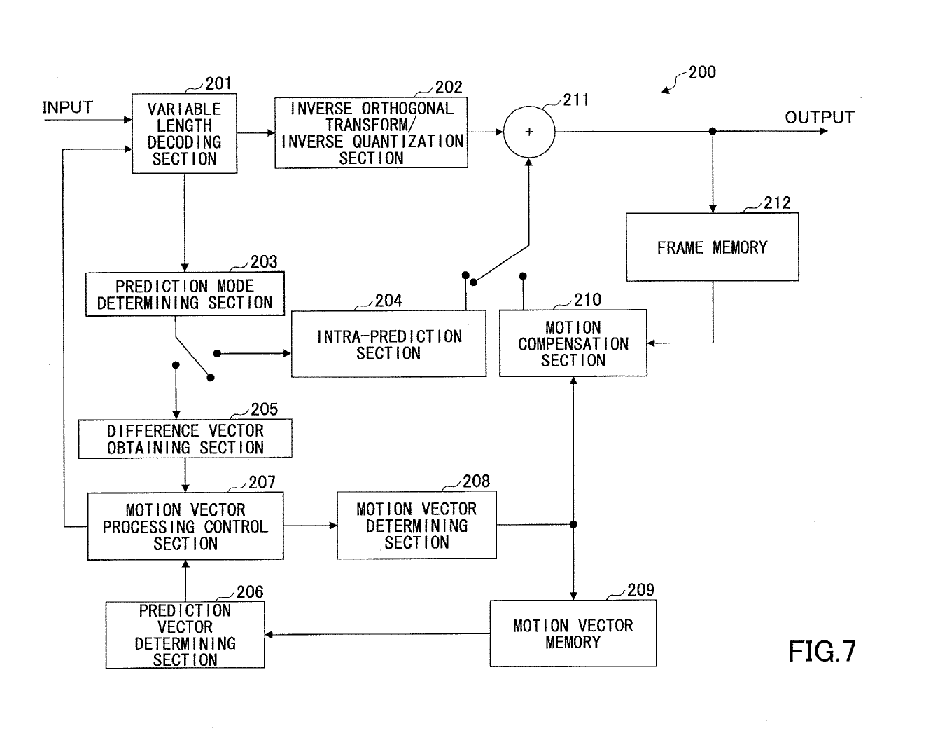

FIG. 7 is a block diagram illustrating an example of a configuration of a moving image decoding apparatus 200 according to the second embodiment. The moving image decoding apparatus 200 illustrated in FIG. 7 includes a variable-length decoding section 201, an inverse orthogonal transform/inverse quantization section 202, a prediction mode determining section 203, an intra-prediction section 204, and a difference vector obtaining section 205. The moving image decoding apparatus 200 also includes a predicted motion vector determining section 206, a motion vector processing control section 207, a motion vector determining section 208, a motion vector memory 209, a motion compensation section 210, a decoded image generating section 211, and a frame memory 212.

The moving image encoding apparatus 200 illustrated in FIG. 7 illustrates a configuration for decoding a non-base-view input bitstream. Among the sections above, sections other than the motion vector processing control section 207 are also to be provided for decoding base-view moving images, but they are omitted here to avoid duplicated description. This is also applicable to moving image decoding apparatuses that will be described later.

A decoding process for a non-base-view moving image will be described. When a non-base-view bitstream is input, the variable-length decoding section 201 executes variable-length decoding that corresponds to variable-length encoding by the moving image encoding apparatus 100. A predicted error difference signal or the like decoded by the variable-length decoding section 201 is output to the inverse orthogonal transform/inverse quantization section 202. The data to be decoded includes various header information such as SPS (Sequence Parameter Set, a sequence header) and PPS (Picture Parameter Set, a picture header) and the like, and data such as a prediction mode, a motion vector, and difference coefficient information for each MB in a picture.

The inverse orthogonal transform/inverse quantization section 202 applies inverse quantization to the output signal from the variable-length decoding section 201. The inverse orthogonal transform/inverse quantization section 202 applies inverse orthogonal transform to the output signal having inverse quantization applied to generate a residual difference signal. The residual difference signal is output to the decoded image generating section 211.

For each MB, the prediction mode determining section 203 determines which prediction mode is used among the modes of intra-frame encoding, forward-directional predictive encoding, backward-directional predictive encoding, bidirectional predictive encoding, and the direct mode, by reading the decoded data. In practice, the size of block partitioning and the like are included in the prediction mode.

Once the prediction mode of an MB is determined, decoding is executed depending on the prediction mode. For intra-frame encoding, the intra-prediction section 204 reads the mode information for intra-prediction to execute intra-prediction.

The intra-prediction section 204 decodes a direction of intra-prediction or the like, executes calculation for surrounding pixels, and executes intra-prediction to decode the block image. The decoded image is recorded at a position for the block to be decoded in the frame memory 212 if it is a block in the referenced picture, which can be referenced from a block to be decoded next.

For inter-prediction, the difference vector obtaining section 205 obtains a difference vector of the block to be decoded.

If it is the direct mode, the predicted motion vector determining section 206 reads out a motion vector mvCol (motion vector of the co-located macroblock) among decoded motion vectors accumulated in the motion vector memory 209 during the decoding process of colPic (co-located Picture) that has been decoded. The predicted motion vector determining section 206 calculates a direct vector by applying scaling to mvCol.

The predicted motion vector determining section 206 reads motion vectors of the surrounding blocks that has been already decoded from the motion vector memory 209 to determine the predicted motion vector.

The motion vector processing control section 207 controls the decoding process of the motion vector based on the reference destination information of the obtained difference vector and/or the reference destination information of the predicted motion vector.

The motion vector determining section 208 determines the motion vector by adding the difference vector to the predicted motion vector. The determined motion vector is written into the motion vector memory 209 and indicated to the motion compensation section 210.

The motion vector memory 209 stores a motion vector of a decoded block and reference destination information designating the reference destination of the motion vector. The motion vector memory 209 is, for example, a memory section.

The motion compensation section 210 executes motion compensation based on the calculated direct vector or the determined motion vector and a reference image obtained from the frame memory 212.

The decoded image generating section 211 generates a decoded image by adding a prediction image output from the intra-prediction section 204 or the motion compensation section 210 to the residual difference signal output from the inverse orthogonal transform/inverse quantization section 202. The generated decoded image is displayed on the display section or output to the frame memory 212.

The frame memory 212 stores images that are locally decoded. The frame memory 212 may also store reference images of other views.

<Operations>

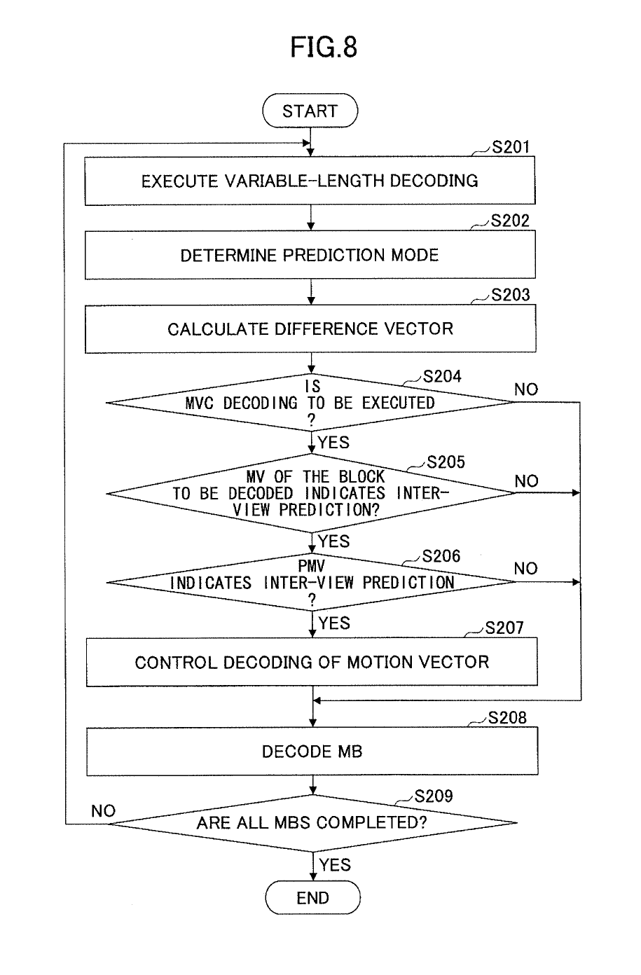

Next, operations of the moving image encoding apparatus 200 will be described according to the second embodiment. FIG. 8 is a flowchart illustrating a moving image decoding process according to the second embodiment.

At Step S201, the variable-length decoding section 201 applies variable-length decoding to an input stream.

At Step S202, the prediction mode determining section 203 determines the prediction mode of the block to be decoded by reading the decoded data.

At Step S203, the difference vector obtaining section 205 obtains the difference vector of the block to be decoded from the prediction mode determining section 203.

At Step S204, the motion vector processing control section 207 determines whether to apply MVC-decoding to the block to be decoded. If applying MVC-decoding (Step S204—YES), Step 205 is taken, or if not applying MVC-decoding (Step S204—NO), Step 208 is taken.

At Step 205, the motion vector processing control section 207 determines whether the motion vector of the block to be decoded designates inter-view prediction. Inter-view prediction or not can be determined based on whether the reference destination information of the block to be decoded references an intra-view picture or an inter-view picture.

If the motion vector references an inter-view picture (Step S205—YES), Step 206 is taken, or if not (Step S205—NO), Step 208 is taken.

At Step 206, the motion vector processing control section 207 determines whether the predicted motion vector PMV determined by the predicted motion vector determining section 206 designates inter-view prediction. If the predicted motion vector PMV designates the inter-view prediction (Step S206—YES), Step 2007 is taken, otherwise (Step S206—NO), Step 208 is taken.

At Step 207, the motion vector processing control section 207 controls the decoding process of the motion vector.

At Step 208, the intra-prediction section 204, the motion compensation section 210, the decoded image generating section 211, and the like decode the MB data.

At Step 209, the moving image encoding apparatus 200 determines whether the decoding process has been applied to all of the MBs. If all of the MBs are completed (Step S209—YES), the decoding process is terminated, otherwise (Step S209—NO), the procedure goes back to Step 201.

As above, according to the second embodiment, it is possible to appropriately decode encoded data with a reduced encoding amount for a motion vector by decoding in the reverse order of the encoding process according to the first embodiment.

### Third Embodiment

Next, a moving image encoding apparatus will be described according to a third embodiment. In the third embodiment, a context of CABAC is changed depending on a relationship between the reference destination (ref_idx_Curr) of the motion vector of a block to be encoded bCurr and the reference destination (ref_idx_X) of the predicted motion vector.

<Configuration>

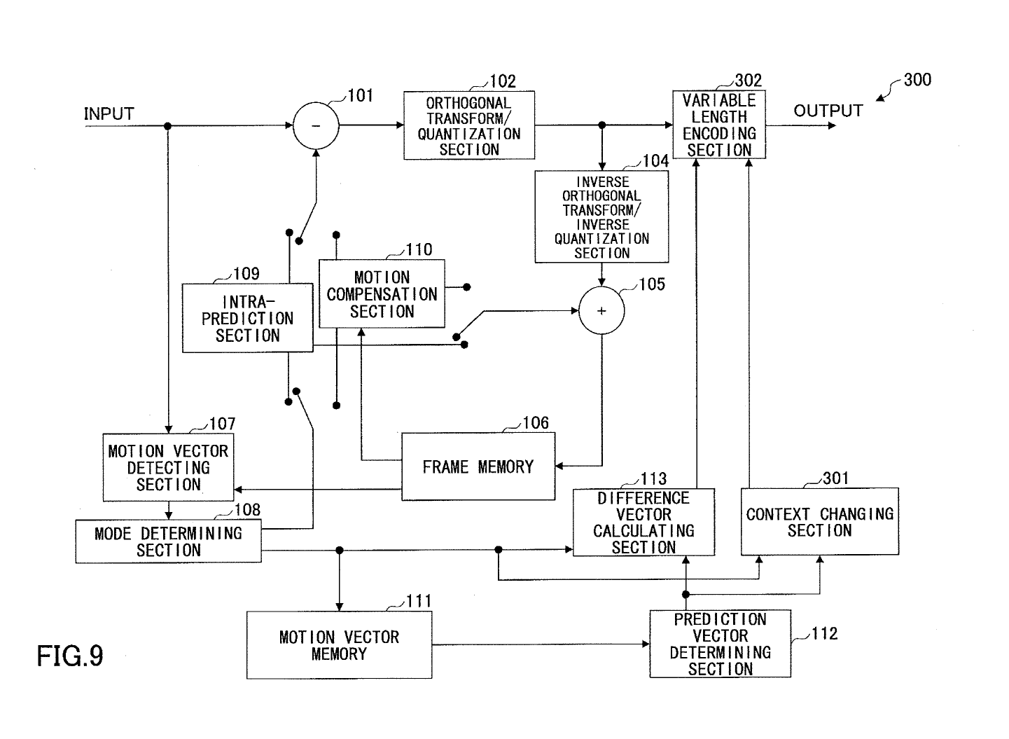

FIG. 9 is a block diagram illustrating an example of a configuration of a moving image encoding apparatus 300 according to the third embodiment. In the configuration illustrated in FIG. 9, the same elements as in the configuration illustrated in FIG. 4 are assigned with the same numeric codes, and their explanation is omitted. Therefore, a context changing section 301 and a variable-length encoding section 302 are mainly described in the following.

The context changing section 301 changes the context of the variable-length encoding of a motion vector depending on a relationship between the reference destination (ref_idx_Curr) of the motion vector of a block to be encoded bCurr and the reference destination (ref_idx_X) of the predicted motion vector. Here, the reference destination X is one of the surrounding blocks such as bA, bB, bC, or the like.

In general, correlations of motion vectors that arise from difference between an inter-view reference and an inter-view reference have tendencies illustrated in FIG. 5. Therefore, the context changing section 301 changes the variable-length encoding of motion vectors so that zero vector is assigned with a short code if the correlation of the motion vectors is high.

For example, encoding in H.264 or later adopts an encoding method called CABAC (Context-Based Adaptive Binary Arithmetic Coding) to encode an MB layer other than the header information.

CABAC is described in the chapter “9.3 CABAC parsing process for slice data” in the reference document of H.264. For more details, refer to “Context-Based Adaptive Binary Arithmetic Coding in the H.264/AVC Video Compression Standard”, IEEE TRANSACTION ON CIRCUITS AND SYSTEMS FOR VIDEO TECHNOLOGY, Vol 13, No. 7, JULY 2003.

To put it simply, CABAC includes the following encoding steps:

(1) Binarization (representing zeros and ones)
(2) Context modeling
(3) Binary arithmetic coding

The context changing section 301 controls the above step (2). Context modeling of the step (2) uses frequency distribution tables, which are distribution tables for frequencies of symbols. Different frequency distribution tables are provided depending on a binarization tendency of the elements. The frequency distribution tables adaptively change in response to a processing result for each context model.

For example, as illustrated in FIG. 5, if the correlation of motion vectors has deviation, it is possible to execute more efficient CABAC encoding by providing context models for factors that produce the deviation.

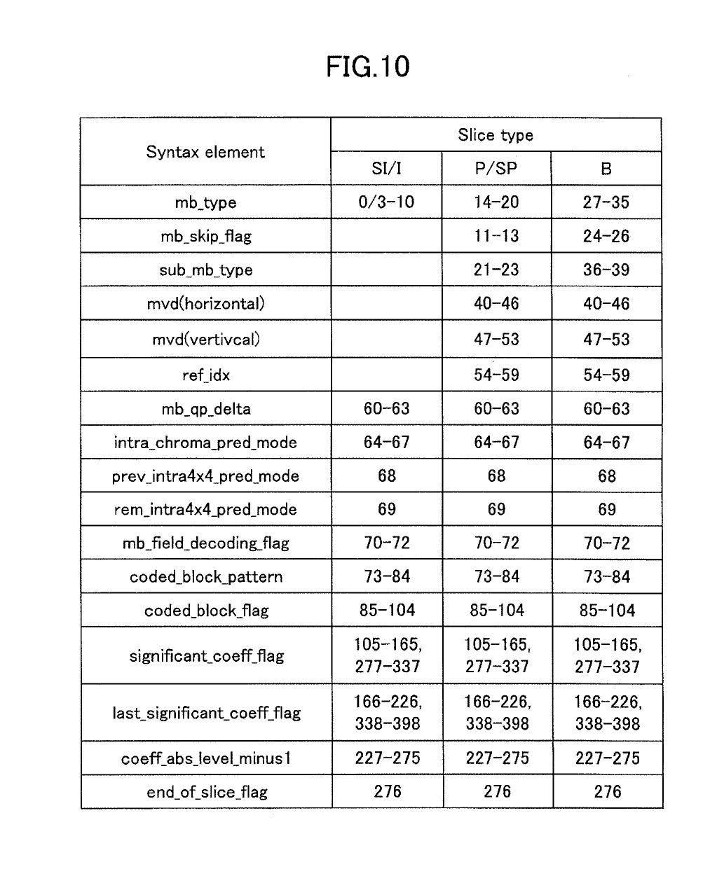

FIG. 10 is an element table illustrating context models for CABAC according to H.264, with respect to syntax elements and associated range of context indices that identify the context models. As illustrated in FIG. 10, context models are defined for Slice types (I-Slice, P-Slice, B-Slice) with syntax elements including motion vector component (mvd), reference destination picture number (ref_idx), quantization code (mb_qp_delta), intra-prediction mode (intra_pred_mode), block validness/invalidness (codec_block_pattern), orthogonal transform coefficient (significant_coeff_flag), and the like.

Context models can be changed, for example, by adding a determination result on whether ref_idx_Curr and ref_idx_X reference the same reference destination, and adding a characteristic of the correlation.

For example, the elements (ctxIdx) of the context models illustrated in FIG. 10 may be increased. As for context related to a motion vector, horizontal components of a difference vector are assigned with context indices (ctxIdx) of 40-46 in FIG. 10, and vertical components are assigned with 47-53, according to H.264. Context description for a motion vector is described in 9.3.3.1.1.7 in the reference document of H.264. The present embodiment follows the reference document. Although seven ctxIdx, 40-46 or 47-53, are assigned according to H.264, one may consider that context models are further divided by two conditions (ref_idx_Curr is inter-view and ref_idx_X is inter-view, or otherwise), or three conditions (ref_idx_Curr is inter-view and ref_idx_X is inter-view, ref_idx_Curr is intra-view and ref_idx_X is intra-view, or otherwise) by determining with FIG. 5.

For example, only deviation of vertical vectors may be focused on. In this case, the current context models with ctxIdx of 47-53 may be further increased depending on a relationship between the reference destination (ref_idx_Curr) of the motion vector of a block to be encoded bCurr and the reference destination (ref_idx_X) of the predicted motion vector.

If it is increased twofold by separately managing only a case where both ref_idx_Curr and ref_idx_X are inter-view references, twofold ctxIdx's are assigned to vertical components of a difference vector.

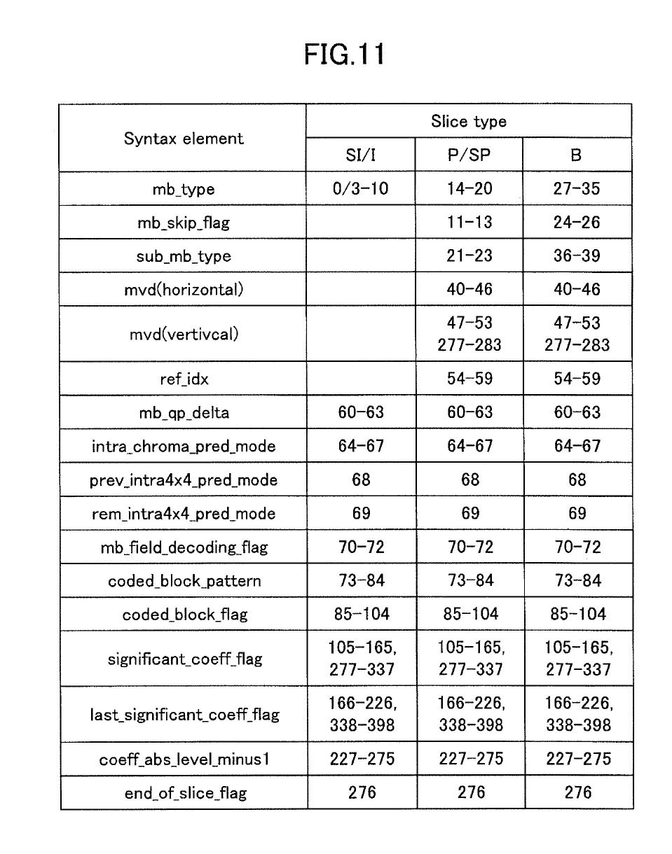

FIG. 11 is a schematic view illustrating a first element table of a context model according to the third embodiment. As illustrated in FIG. 11, vertical components of a difference vector are assigned with 47-53 and 277-283. Thus, the twofold indices can be used.

Moreover, if it is increased threefold by separating a case where both ref_idx_Curr and ref_idx_X are intra-view references, threefold ctxIdx's are assigned to vertical components of a difference vector.

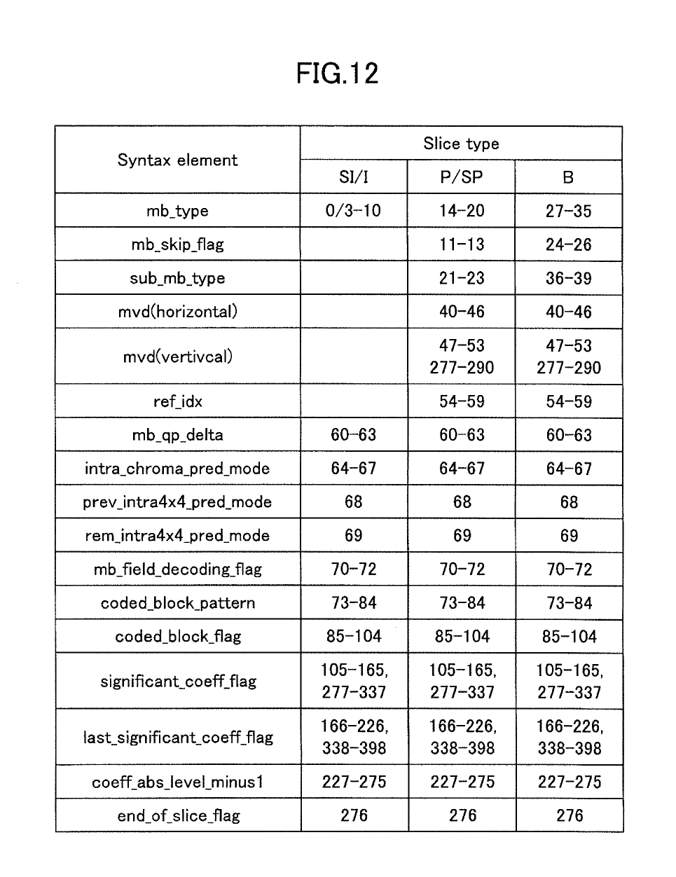

FIG. 12 is a schematic view illustrating a second element table of a context model according to the third embodiment. As illustrated in FIG. 12, vertical components of a difference vector are assigned with 47-53 and 277-290. Thus, the threefold indices can be used.

Indices may be added after the maximum index of conventional ctxIdx as described above, or alternatively, for example, ctxIdx for mvd (vertical) may be renumbered with serial numbers such as 47-60 instead of 47-53 and ctxIdx for mvd (horizontal) may be assigned with 61 and greater to change the element table. This is also applicable when increasing ctxIdx for horizontal components.

Context models have variables m and n required for initialization for ctxIdx. The values of m and n are described, for example, in the section “9.3.1.1 initialization” of H.264 reference document. These are variables to represent initial values of degrees of deviation of 0s and 1s for a binarized signal.

As for the variables m and n, the original values of m and n used for the original ctxIdx of 47-53 may be used for 277-283 or 284-290 if ctdIdx for mvd is increased. As frequency distributions are adaptively changed with probabilities of binary variables generated for each ctxIdx, or the context models, distinctions may be made with the following conditions.

(1) ref_idx_Curr is an inter-view reference and ref_idx_X is an inter-view reference.
(2) ref_idx_Curr is an intra-view reference and ref_idx_X is an intra-view reference.
(3) ref_idx_Curr is an intra-view reference and ref_idx_X is an inter-view reference, or ref_idx_Curr is an inter-view reference and ref_idx_X is an intra-view reference.

With the above conditions, specific deviation of difference vectors may arise, which changes the frequency distribution and makes it possible to execute CABAC encoding suitable for the conditions.

Especially, for the case of the condition (1) of inter-view reference vectors, most vertically directed motion vectors become zero vectors, and difference vectors also become zero vectors. Therefore, the context change (adding ctxIdx) is effective because vectors have a specific tendency depending on whether they are inter-view reference vectors.

<Operations>

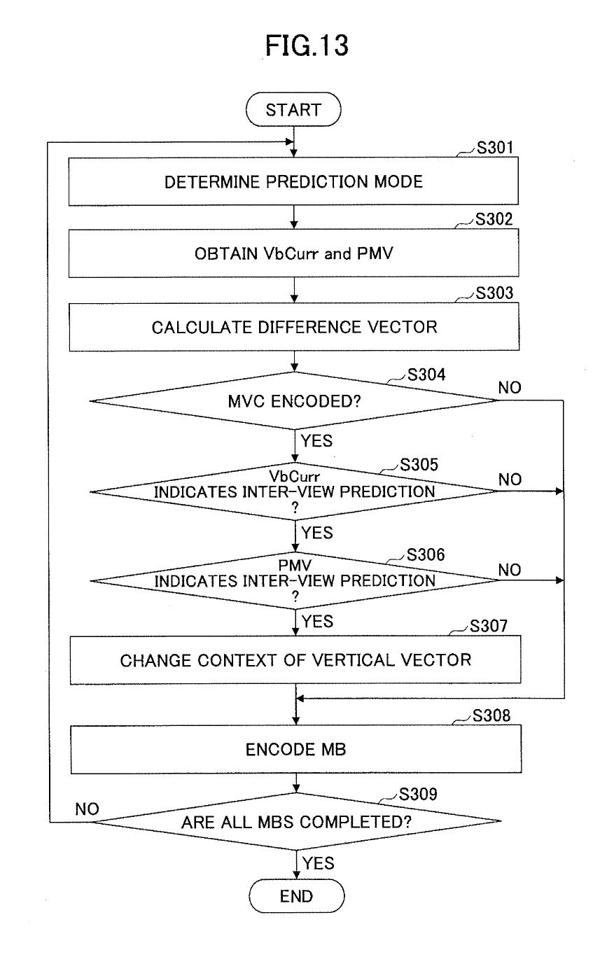

Next, operations of the moving image encoding apparatus 300 will be described according to the second embodiment. FIG. 13 is a flowchart illustrating a moving image encoding process according to the third embodiment. Steps S301-S306 and S309 illustrated in FIG. 13 are substantially the same as Steps S101-S106 and S109 illustrated in FIG. 6, respectively, and their description is omitted.

At Step S307, the context changing section 301 changes the context of a vertical vector depending on a relationship between reference destinations of the block to be encoded and the surrounding blocks. The context changing section 301 changes the context, for example, by separating cases with the relationship illustrated in FIG. 5. In this way, a frequency distribution is generated suitable for the relationship to raise the encoding efficiency.

At Step S308, the variable-length encoding section 302 executes variable-length encoding for the quantized value of the MB. The variable-length encoding section 302 executes CABAC encoding for the difference vector using a context model corresponding to the context changed by the context changing section 301.

As above, according to the third embodiment, variable-length encoding tendency of difference vectors is changed depending on a relationship between the reference destinations (ref_idx_bCurr, ref_idx_bX) of a block to be encoded (bCurr) and the surrounding blocks (bX). This concept may be referred to as, for example, a concept of changing CABAC context. Conventionally, an efficient motion vector encoding is not realized because there are no concepts of changing CABAC context performed depending on variable-length encoding tendency of difference vectors.

However, as described with the third embodiment, the encoding efficiency can be improved by changing context models depending on a relationship between the reference destinations (ref_idx_bCurr, ref_idx_bX) of a block to be encoded (bCurr) and the surrounding blocks (bX) and using frequency distributions suitable for the relationship.

### Fourth Embodiment

Next, a moving image decoding apparatus will be described according to the fourth embodiment. In the fourth embodiment, data encoded by the moving image encoding apparatus 300 according to the third embodiment is decoded.

<Configuration>

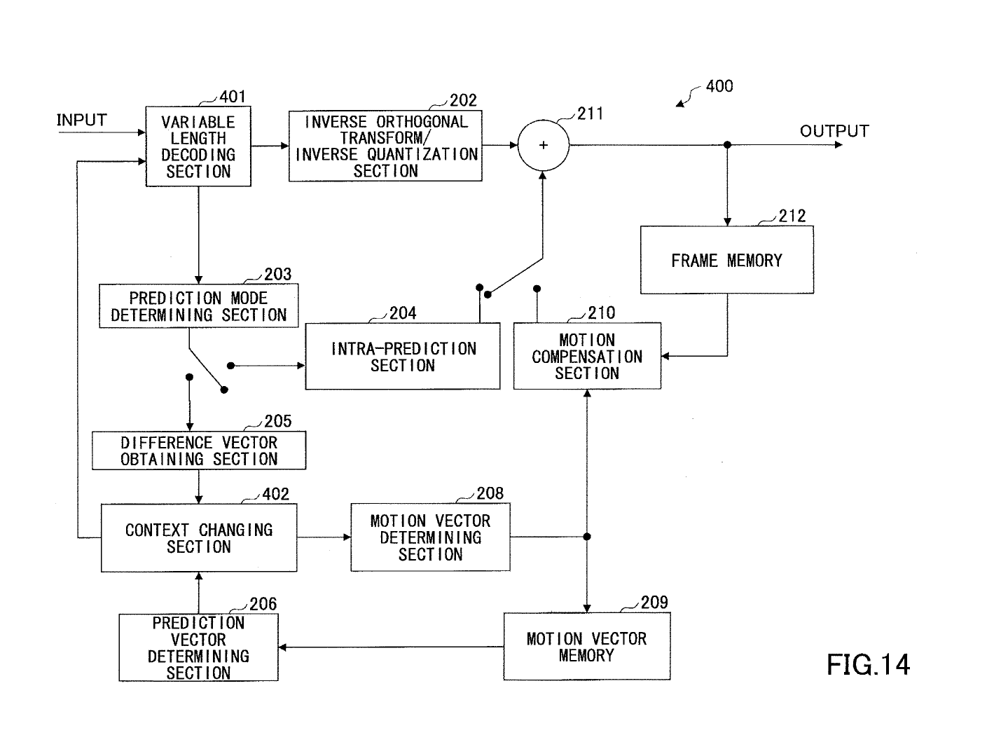

FIG. 14 is a block diagram illustrating an example of a configuration of a moving image decoding apparatus 400 according to the fourth embodiment. In the configuration illustrated in FIG. 14, the same elements as in the configuration illustrated in FIG. 7 are assigned with the same numeric codes, and their explanation is omitted. Therefore, in the following, a variable-length decoding section 401 and a context changing section 402 will be mainly described.

The variable-length decoding section 401 applies variable-length decoding to an input stream to obtain a predicted error difference signal and the like. The data to be decoded includes various header information such as SPS (sequence header), PPS (picture header) and the like, and data of MBs in a picture such as prediction modes, motion vectors, difference coefficient information, and the like.

For example, the variable-length decoding section 401 executes a decoding process corresponding to CABAC, and the context changing section 402 updates frequency distributions with context models.

The context changing section 402 executes similar processing as the context changing section 301 described with the third embodiment to control the CABAC context models. The context changing section 402 feeds back a reference destination of the motion vector obtained from the difference vector obtaining section 205 and a reference destination of the predicted motion vector obtained from the predicted motion vector determining section 206 to the variable-length decoding section 401. Thus, the frequency distributions for the variable-length decoding section 401 can be updated appropriately with the context models.

<Operations>

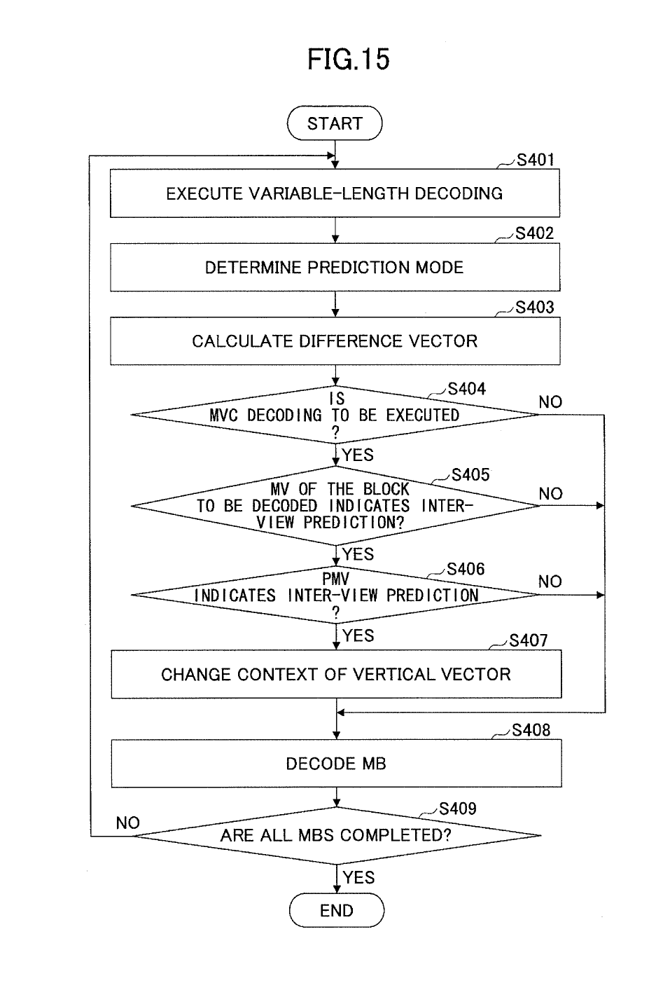

Next, operations of the moving image decoding apparatus 400 will be described according to the fourth embodiment. FIG. 15 is a flowchart illustrating a moving image decoding process according to the fourth embodiment. Steps S402-S406 and S408-S409 illustrated in FIG. 15 are substantially the same as Steps S202-S206 and S208-S209 illustrated in FIG. 8, respectively, and their description is omitted.

At Step S401, the variable-length decoding section 401 decodes an input stream, for example, by a decoding method corresponding to the CABAC encoding. The frequency distribution is updated by the context changing section 402 with the CABAC context models.

At Step S407, the context changing section 402 controls, for example, updating of context of vertical vectors with the context models, depending on the motion vector of the block to be decoded and the reference destination of the predicted motion vector.

As above, according to the fourth embodiment, it is possible to appropriately decode encoded data with a reduced encoding amount for a motion vector by decoding in the reverse order of the encoding process according to the third embodiment.

### Fifth Embodiment

Next, a moving image encoding apparatus will be described according to a fifth embodiment. In the fifth embodiment, a predicted motion vector itself is changed.

<Configuration>

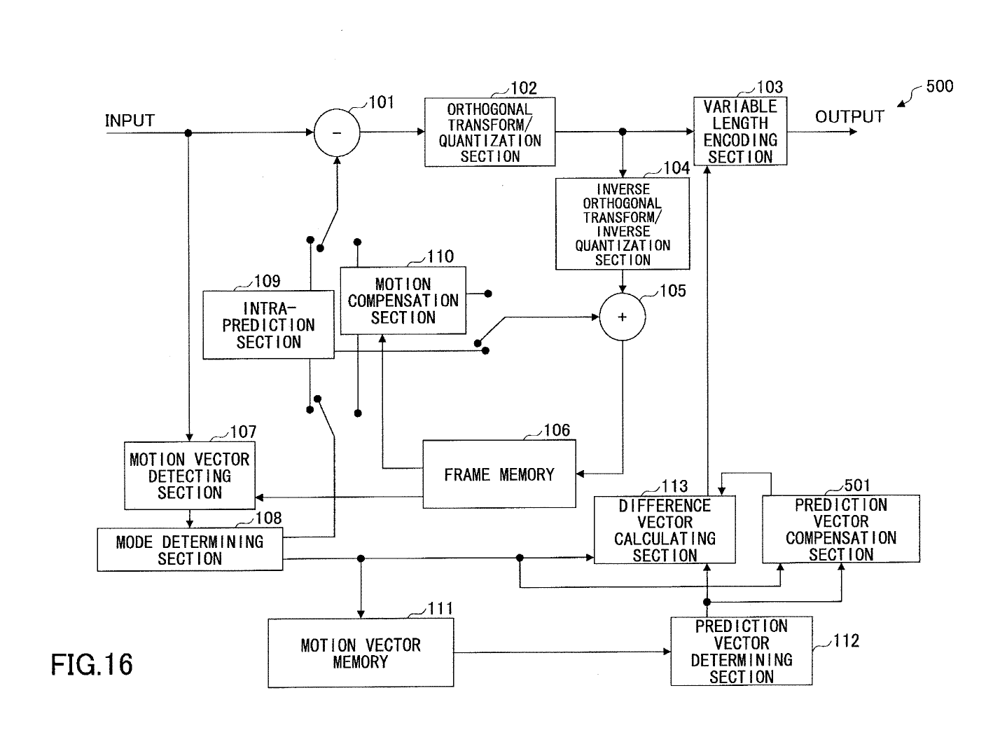

FIG. 16 is a block diagram illustrating an example of a configuration of a moving image encoding apparatus 500 according to the fifth embodiment. In the configuration illustrated in FIG. 16, the same elements as in the configuration illustrated in FIG. 4 are assigned with the same numeric codes, and their explanation is omitted. Therefore, in the following, a predicted motion vector compensation section 501 will be mainly described.

The predicted motion vector compensation section 501 compensates a predicted motion vector itself based on reference destinations (ref_idx_bCurr, ref_idx_bX) of a block to be encoded (bCurr) and/or surrounding blocks (bX). An example of compensation of a predicted motion vector will be described below.

### Compensation Example 1

The predicted motion vector compensation section 501 determines how to compensate a predicted motion vector with conditions such as the motion vector VbCurr=(VbCurrx, VbCurry) of a block to be encoded, the predicted motion vector PMV=(PMVx, PMVy) and the like. For example, the predicted motion vector compensation section 501 executes the following control depending on whether the reference destination ref_idx_Curr of the motion vector of the block to be encoded is an inter-view reference.

Case where ref_idx_Curr is an inter-view reference The predicted motion vector compensation section 501 compensates PMVy=0.
Case where ref_idx_Curr is not an inter-view reference
The predicted motion vector compensation section 501 does not compensate PMVy.

In this way, it is possible to make a difference of a motion vector smaller by a simple process. Here, this compensation example 1 is also effective for making a difference of a motion vector smaller if combined with context model changing in the third embodiment.

### Compensation Example 2

If a motion vector of a block to be encoded is an inter-view reference, not only the vertical component of the motion vector becomes almost zero, but also there are cases in which a certain tendency of the horizontal component is found.

For example, the horizontal component of a motion vector with an inter-view reference tends to take a value close to a fixed value A. For 3D video, left and right images have a certain distance in the horizontal direction to produce a popping-out effect

The distance is called disparity. In the compensation example 2, a tendency is used in that the disparity does not fluctuate much in an encoding image.

The predicted motion vector compensation section 501 determines how to compensate a predicted motion vector with conditions such as the motion vector VbCurr=(VbCurrx, VbCurry) of a block to be encoded, the predicted motion vector PMV=(PMVx, PMVy) and the like. For example, the predicted motion vector compensation section 501 executes the following control depending on whether the reference destination ref_idx_Curr of the motion vector of the block to be encoded is an inter-view reference.

Case where ref_idx_Curr is an inter-view reference The predicted motion vector compensation section 501 compensates PMVx=A.
Case where ref_idx_Curr is not an inter-view reference
The predicted motion vector compensation section 501 does not compensate PMVx.

In this way, it is possible to make a difference of a motion vector smaller. The predicted motion vector compensation section 501 calculates A with the following formula (3) using motion vectors of inter-view reference blocks in already-decoded pictures.

$$A = {\sum }_{block} ( {MVx}_{block} ) / num\_interView \qquad formula ( 3 )$$

num_interView: the number of inter-view reference blocks

The predicted motion vector compensation section 501 may calculate A, for example, by averaging motion vectors with inter-view references that have already been processed in the current picture. Also, the predicted motion vector compensation section 501 may restrict the number of blocks within a certain range instead of using all blocks that can be referenced.

Also, the predicted motion vector compensation section 501 may partition a picture into predetermined areas to calculate A for each of the predetermined areas. Also, the predicted motion vector compensation section 501 may calculate A as a representative value of motion vectors with inter-view references, instead of as the average value. As above, A can be calculated in various ways. Also, the compensation example 2 may be combined with the third embodiment and/or the compensation example 1.

<Operations>

Next, operations of the moving image encoding apparatus 500 will be described according to the fifth embodiment. First, a moving image encoding process, in which a predicted motion vector is compensated as in the compensation example 1, will be described.

### Compensation Example 1

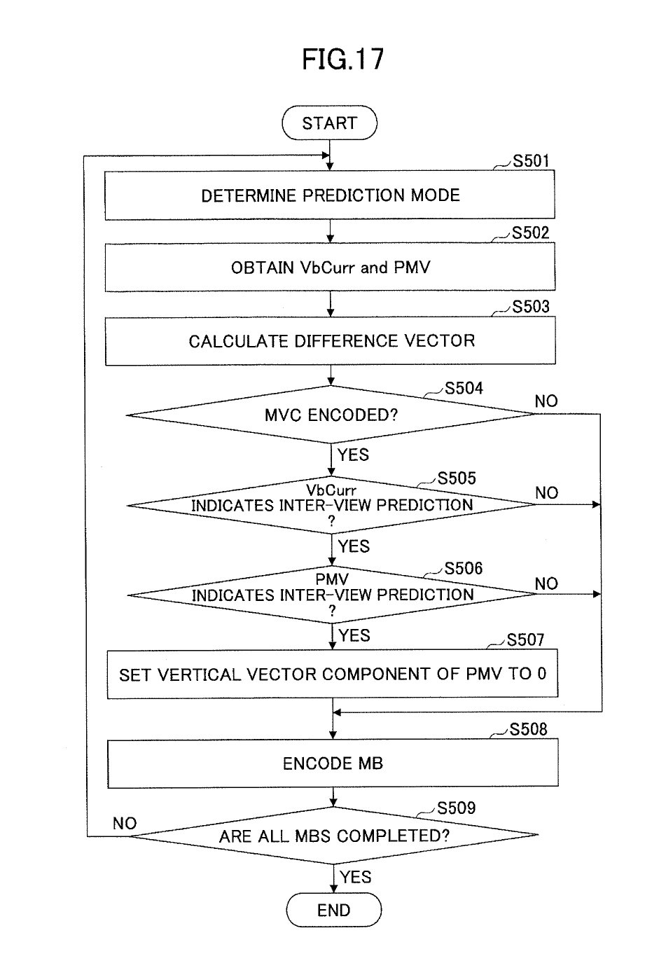

FIG. 17 is a flowchart illustrating a first moving image encoding process according to the fifth embodiment. Steps S501-S506 and S508-S509 illustrated in FIG. 17 are substantially the same as Steps S101-S106 and S108-S109 illustrated in FIG. 6, respectively, and their description is omitted. Here, determination at Step S506 may be skipped.

At Step S507, the predicted motion vector compensation section 501 compensates the vertical vector component of the predicted motion vector PMV to zero if the reference destination ref_idx_Curr of the motion vector of a block to be encoded designates an inter-view prediction. This generates a difference vector between the motion vector of the block to be encoded and the compensated predicted motion vector.

### Compensation Example 2

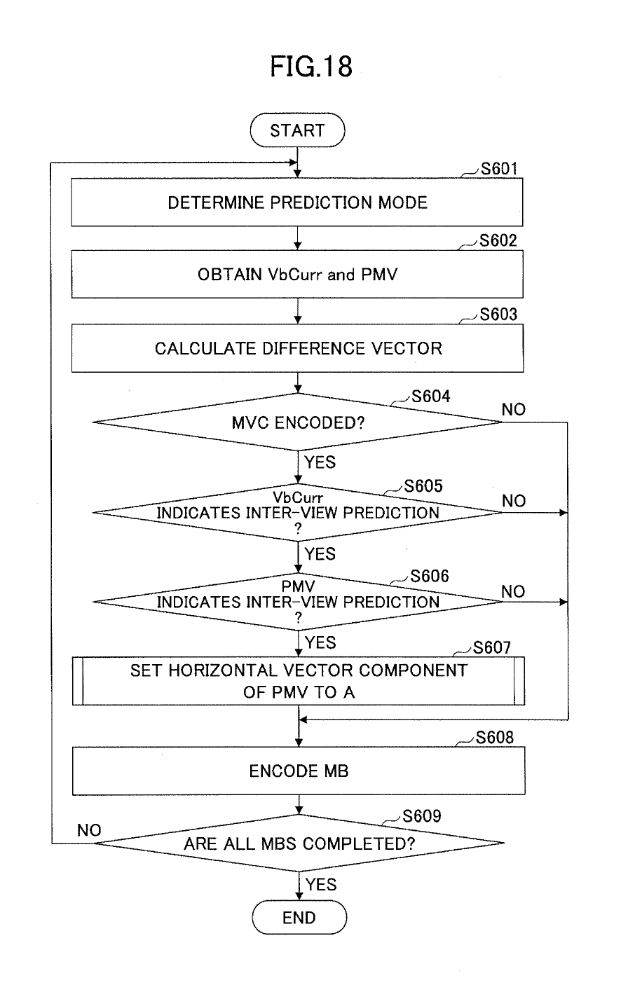

FIG. 18 is a flowchart illustrating a second moving image encoding process according to the fifth embodiment. Steps S601-S606 and S608-S609 illustrated in FIG. 18 are substantially the same as Steps S101-S106 and S108-S109 illustrated in FIG. 6, respectively, and their description is omitted. Here, determination at Step S606 may be skipped.

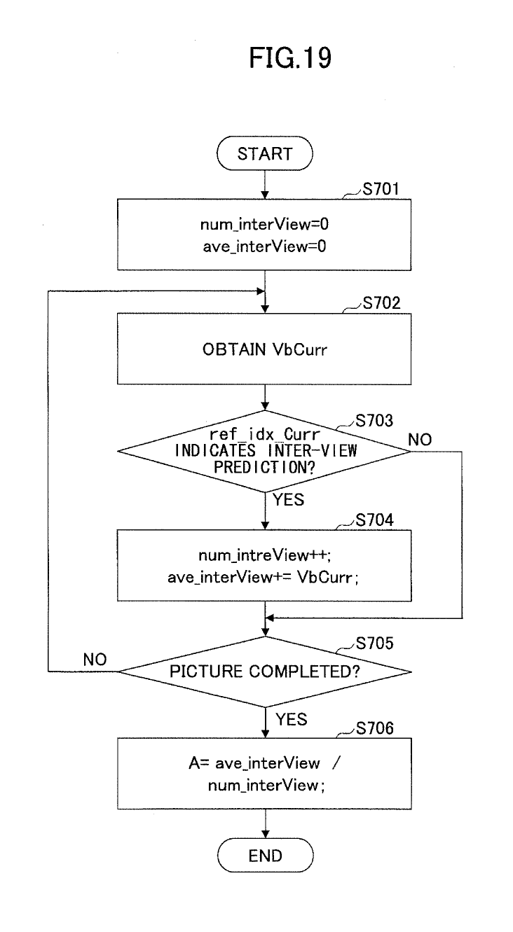

At Step S607, the predicted motion vector compensation section 501 compensates the horizontal vector component of the predicted motion vector PMV to A if the reference destination ref_idx_Curr of the motion vector of a block to be encoded designates an inter-view prediction. Calculation of A will be described later with FIG. 19. This generates a difference vector between the motion vector of the block to be encoded and the compensated predicted motion vector.

(Calculation of A)

FIG. 19 is a flowchart illustrating a calculation process of A according to the fifth embodiment. At Step S701, the predicted motion vector compensation section 501 initializes the following parameters.

num_interView=0
ave_interView=0
where ave_interView is an accumulated value of components of a motion vector for inter-view prediction.

At Step S702, the predicted motion vector compensation section 501 obtains the motion vector VbCurr of a block to be encoded.

At Step S703, the predicted motion vector compensation section 501 determines whether the reference destination ref_idx_Curr of the motion vector of the block to be encoded designates inter-view prediction. If designating inter-view prediction (Step S703—YES), Step S704 is taken, if not designating inter-view prediction (Step S703—NO), Step S705 is taken.

At Step S704, the predicted motion vector compensation section 501 updates the parameters.

num_interView++
ave_interView+=VbCurr

At Step S705, the predicted motion vector compensation section 501 determines whether processing of one picture ends. If the processing of one picture ends (Step S705—YES), Step S706 is taken, otherwise (Step S705—NO), the procedure goes back to Step S702.

At Step S706, the predicted motion vector compensation section 501 calculates A with the following formula (4).

A=ave_interView/num_interView formula (4)

Here, Step S706 may be executed before Step S705.

As above, according to the fifth embodiment, it is possible to reduce the encoding amount of a motion vector in an encoding process of the motion vector by controlling the encoding process based on the motion vector of a block to be encoded and and/or reference destination information of the predicted motion vector.

### Sixth Embodiment

Next, a moving image encoding apparatus will be described according to a sixth embodiment. In the sixth embodiment, a predicted motion vector itself is changed in a decoding process.

<Configuration>

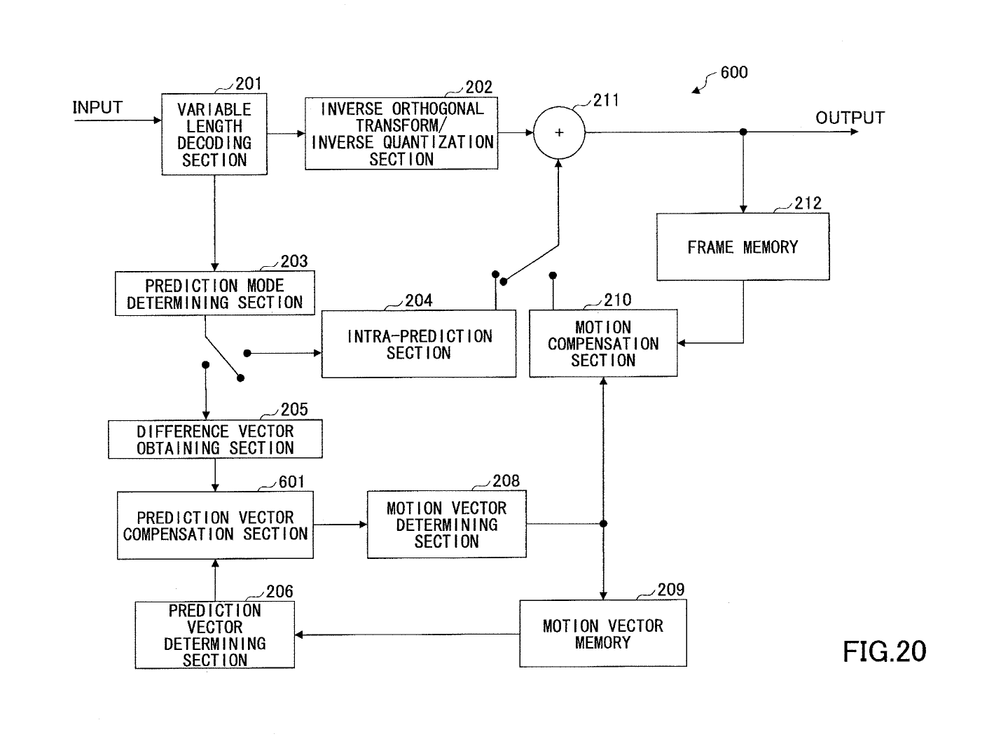

FIG. 20 is a block diagram illustrating a configuration of a moving image decoding apparatus 600 according to the sixth embodiment. In the configuration illustrated in FIG. 20, the same elements as in the configuration illustrated in FIG. 7 are assigned with the same numeric codes, and their explanation is omitted. Therefore, in the following, the predicted motion vector compensation section 601 will be mainly described.

The predicted motion vector compensation section 601 executes substantially the same process as the compensation process executed by the predicted motion vector compensation section 501 in the moving image encoding apparatus 500. For example, the predicted motion vector compensation section 601 compensates components of a predicted motion vector depending on whether the reference destination of the motion vector of a block to be decoded is an inter-view reference.

<Operations>

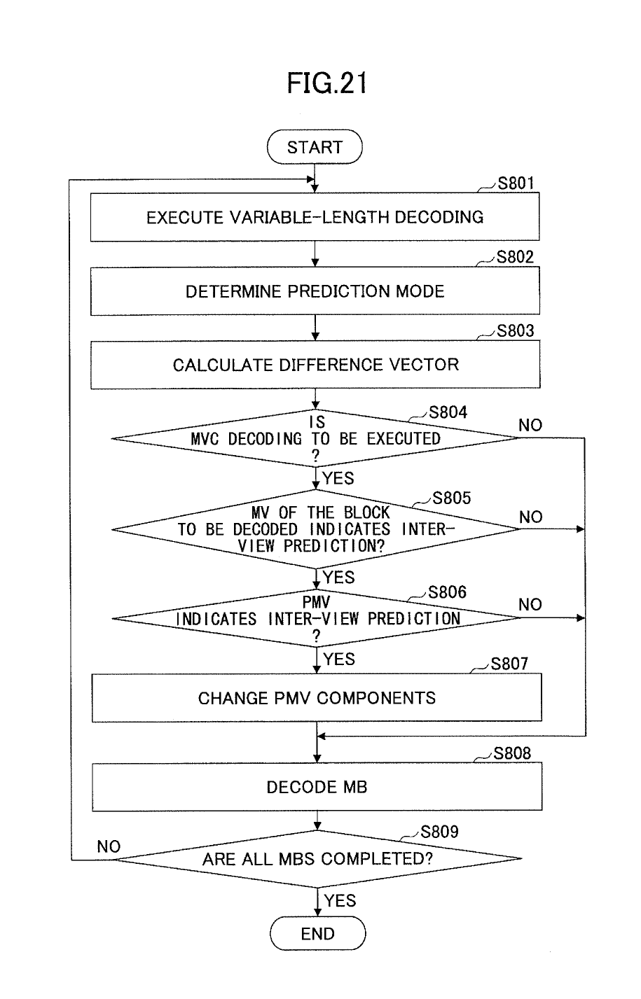

Next, operations of the moving image decoding apparatus 600 will be described according to the sixth embodiment. FIG. 21 is a flowchart illustrating a moving image decoding process according to the sixth embodiment. Steps Step S801-S806 and S808-S809 illustrated in FIG. 21 are substantially the same as Steps 201-S206 and S208-S209 illustrated in FIG. 8, respectively, and their description is omitted. Here, determination at Step S806 may be skipped.

At Step S807, the predicted motion vector compensation section 601 compensates components of the predicted motion vector depending on whether the reference destination of the motion vector of the block to be decoded. The compensation process is substantially the same compensation process as the one executed by the moving image encoding apparatus 500.

As above, according to the sixth embodiment, it is possible to appropriately decode encoded data with a reduced encoding amount for a motion vector by decoding in the reverse order of the encoding process according to the fifth embodiment.

### Seventh Embodiment

Next, a moving image encoding apparatus will be described according to a seventh embodiment. In the seventh embodiment, encoding in HEVC is implemented. In HEVC, as described above, a predicted motion vector candidate is explicitly sent with the index pmvIdx. The index pmvIdx is the identifier of a predicted motion vector.

<Configuration>

The configuration of the moving image encoding apparatus according to the seventh embodiment is substantially the same as the configuration of the moving image encoding apparatus 500 according to the fifth embodiment, hence the moving image encoding apparatus 500 will be used for description. According to the seventh embodiment, the predicted motion vector determining section 112 determines candidates of the predicted motion vector based on motion vectors of surrounding blocks that are temporally and spatially adjacent. The predicted motion vector compensation section 501 sorts indices pmIdx of determined candidates of the predicted motion vector in ascending order to output them to the difference vector calculating section 113.

The difference vector calculating section 113 calculates differences between the motion vector of a block to be encoded and the candidates of the predicted motion vector, then outputs the smallest difference along with its index pmvIdx of the candidate of the predicted motion vector to the variable-length encoding section 103.

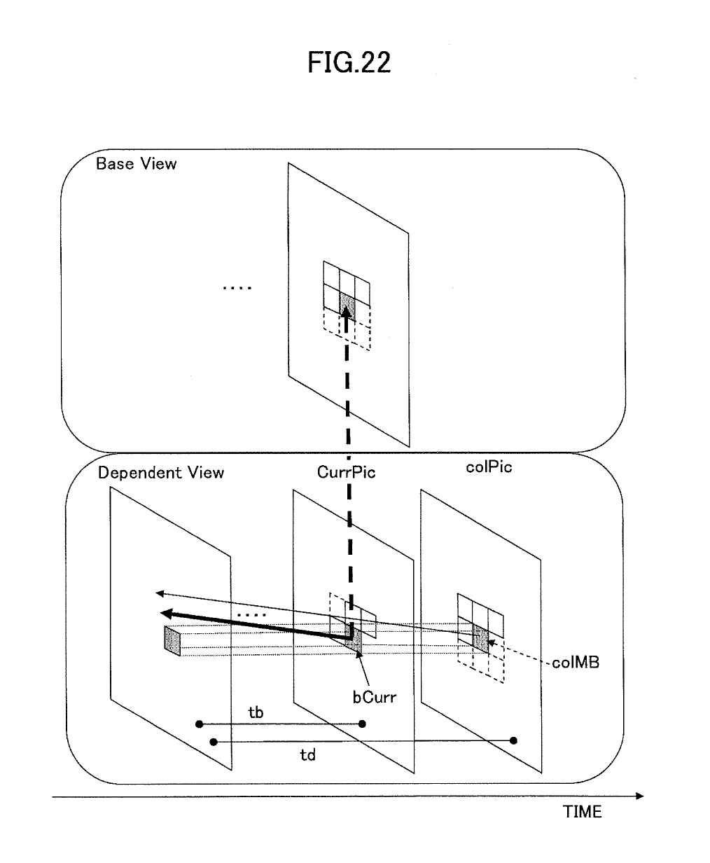

It is noted that MV Competition in HEVC has a problem described below. FIG. 22 is a schematic view illustrating the problem in MV Competition of HEVC. There are cases where scaling is applied to the predicted motion vector even if the reference destination picture of the motion vector VbCurr in time direction differs from the reference destination picture of the predicted motion vector as illustrated in FIG. 22. In the following, scaling is also called MV Scaling.

Scaling is a process to distribute a predicted motion vector in time direction based on a timing relationship between the referencing picture and reference destination picture of the motion vector VbCurr, and the referencing picture and reference destination picture of the predicted motion vector.

In the example illustrated in FIG. 22, tb represents the distance between the referencing picture and reference destination picture of the motion vector VbCurr, and td represents the distance between the referencing picture and reference destination picture of Vcol, with which scaling is applied with the following formula (5).

PMV=Vcol×(tb/td) formula (5)

MV Scaling can be represented by the above formula (5).

However, for example, if an inter-view reference is required for multi-view video encoding (MVC) as designated with a bold dashed line in FIG. 22, the inter-view reference can reference only a picture at the same time. Therefore, in this case, PMV after MV Scaling is performed always becomes zero vector with the above scaling formula where the time difference is zero (tb=0). For this reason, MV Scaling cannot appropriately calculate PMV, and the index pmvIdx cannot be appropriately used for an inter-view reference.

On the other hand, the encoding process for HEVC according to the seventh embodiment can improve the encoding efficiency by making an appropriate index pmvIdx be selected even if a block to be encoded references an inter-view reference.

A generic processing flow of HEVC is as follows.

(1) when starting encoding of a picture, a picture list (refPicList) is determined, which includes pictures that can be referenced as reference destinations from the picture.
(2) the motion vector VbCurr of a block to be encoded is obtained. The reference destination picture can be identified with the reference destination picture index (ref_idx_Curr) held by the motion vector. Information about ref_idx_Curr is accumulated in the motion vector memory 111 as information about the motion vector along with the position of the block to be encoded, components of the motion vector, and the like.
(3) the predicted motion vector PMV is obtained from the surrounding blocks. At this moment, the reference destination picture is identified with ref_idx held by PMV.

For example, in the reference software of HEVC, called TMuC (Test Model under Consideration), pmvIdx is defined as follows.

pmvIdx=0:PMV=median (VbA, VbB, VbC)
pmvIdx=1:PMV=VbA
pmvIdx=2:PMV=VbB
pmvIdx=3:PMV=VbC
pmvIdx=4:PMV=Vcol

MV Competition in HEVC executes scaling if the reference destination picture of VbCurr differs from the reference destination picture of PMV. For example, the motion vector of PMV is compensated with scaling based on a timing relationship between the referencing picture (picture to be encoded) and reference destination picture of the motion vector VbCurr, and the referencing picture and reference destination picture of PMV.

For an inter-view reference in multi-view video encoding (MVC), as described in the above problem, only pictures at the same time can be referenced. In this case, MV Scaling of PMV is not appropriate due to the zero time difference. According to the seventh embodiment, to improve the multi-view (more than two views) encoding efficiency, MV Scaling is controlled as follows.

The predicted motion vector compensation section 501 changes the method of generating pmvIdx depending on components of the reference destination of the candidates of the predicted motion vector PMV and the motion vector. Specifically, the predicted motion vector determining section 112 and the predicted motion vector compensation section 501 generate pmvIdx with the following steps.

(1) As the positions of the reference destination pictures of the motion vectors of surrounding blocks are determined at the moment when they are accumulated into the motion vector memory 111, the values of the positions of the reference destination pictures are read from the motion vector memory 111. The values are represented with ref_idx_A, ref_idx_B, ref_idx_C, and ref_idx_colMB.

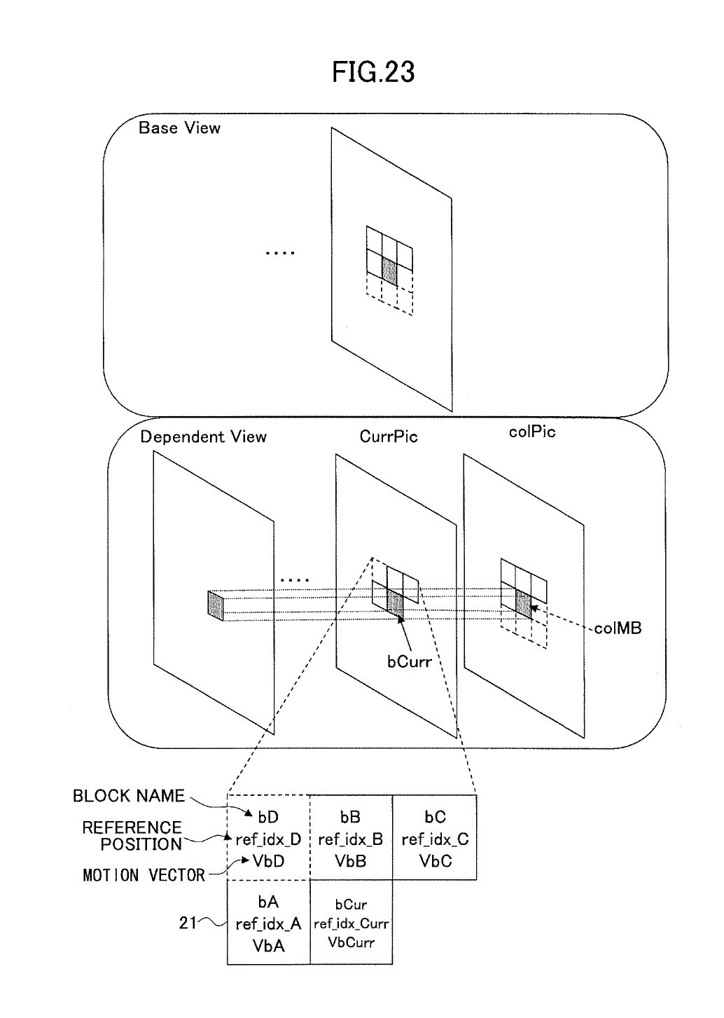

FIG. 23 is a schematic view illustrating the block names, reference positions, and motion vectors of the blocks. For example, the block name of block 21 is bA, the reference position is ref_idx_A, and the motion vector is VbA.

Here, although a median of motion vectors may not match an existing vector because x and y components are calculated respectively, it is assumed to be ref_idx_m. Ref_idx_m is defined as follows.

```
If (VbA, VbB, VbC references the same
reference destination) {
  pmvIdx_m = ref_idx_A
} else if VbA is valid) {
  pmvIdx_m = ref_idx_A
} else if (VbB is valid) {
  pmvIdx_m = ref_idx_B
} else if (VbC is valid) {
  pmvIdx_m = ref_idx_C
} else {
  pmvIdx_m = the maximum value in refPicList
}
```

(2) The motion vector of the current block is processed to obtain ref_idx_Curr.
(3) Previous pmvIdx order is set to default order.
(4) Indices of pmvIdx are sorted by the following steps, by comparing the reference destination information of the motion vector ref_idx_bCurr and the reference destination information of the predicted motion vector.
(4-1) Smaller pmvIdxs are assigned to those having the same reference destination picture (ref_idx).
(4-2) If having the same ref_idx, a smaller pmvIdx is assigned to the one having a smaller vertical distance with B.
(4-3) If having the same ref_idx and the same vertical component of the motion vector, a smaller pmvIdx is assigned to the one having a smaller distance between the horizontal component of the motion vector and A.
(4-4) if having the same motion vector information relevant to steps (4-1) to (4-3), pmvIdxs are assigned in ascending order with respect to the median, bA, bB, bC, colMB.

Here, although the predicted motion vector compensation section 501 may set zero to B, it is not restricted to that, but a representative value of the vertical components of the motion vectors may be obtained that predict the same reference destination as ref_idx_Curr.

Also, although the predicted motion vector compensation section 501 calculates the average of motion vectors with inter-view references for A, it is not restricted to that, but a representative value of the horizontal components of the motion vectors may be obtained that predict the same reference destination as ref_idx_Curr.

The predicted motion vector compensation section 501 can reduce the encoding amount of motion vectors by executing the series of steps (4-1) to (4-4) described above, which introduces a higher likelihood of using a vector that makes the difference vector smaller as the predicted motion vector.

<Operations>

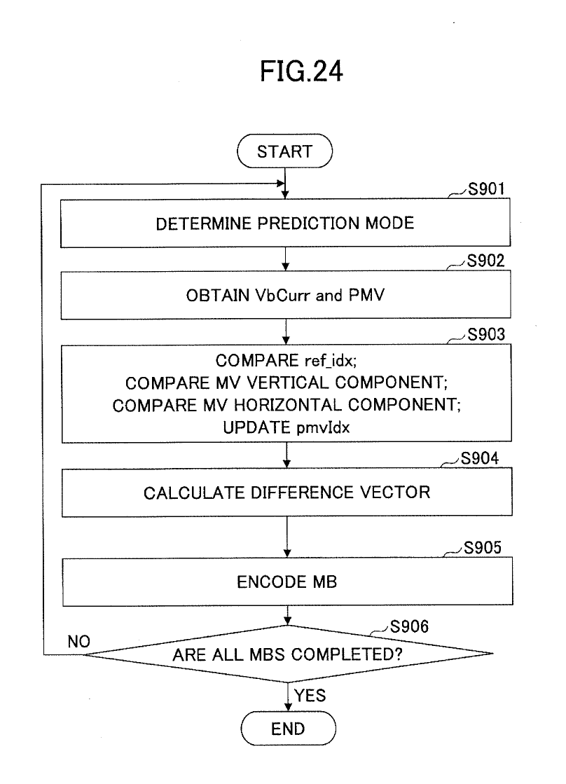

Next, operations of the moving image encoding apparatus will be described according to the seventh embodiment. FIG. 24 is a flowchart illustrating a moving image encoding process according to a seventh embodiment. Steps S901, S902, S905, and S906 illustrated in FIG. 24 are substantially the same as Steps S101, S102, S108, and S109 illustrated in FIG. 6, respectively, and their description is omitted.

At Step S903, the predicted motion vector compensation section 501 compares the reference destination of the motion vector of the block to be encoded and the reference destination of the predicted motion vector. The predicted motion vector compensation section 501 also compares the vertical components and/or horizontal components of the motion vector of the block to be encoded and the predicted motion vector. The predicted motion vector compensation section 501 updates the indices pmvIdx of the candidates of the predicted motion vector based on the comparison result.

At Step S904, the difference vector calculating section 113 calculates differences between the motion vector of the block to be encoded and the candidates of the predicted motion vector, to select the pmvIdx with the smallest difference. This pmvIdx is encoded by the variable-length encoding section 103.

Thus, it is possible to reduce the encoding amount by sorting pmvIdxs depending on the reference destinations of the candidates of the predicted motion vectors and the components of the motion vector, which introduces a higher likelihood of selecting pmvIdx with a small value. pmvIdx is encoded by the variable-length encoding section 103, with an encoding method in which a smaller value is encoded into a shorter code.

### Eighth Embodiment

Next, a moving image decoding apparatus will be described according to the eighth embodiment. In the eighth embodiment, HFVC decoding is executed to decode a stream encoded by the moving image encoding apparatus according to the seventh embodiment.

<Configuration>

The configuration of the moving image decoding apparatus according to the eighth embodiment is substantially the same as the configuration of the moving image decoding apparatus 600 according to the sixth embodiment, hence the moving image decoding apparatus 600 will be used for description. Here, the difference vector obtaining section 205 obtains the index pmvIdx of the decoded predicted motion vector to output it to the predicted motion vector compensation section 601.

Following the sorting rules described in the seventh embodiment, the predicted motion vector compensation section 601 sorts indices of candidates of the predicted motion vector determined by the predicted motion vector determining section 206. The predicted motion vector compensation section 601 identifies the predicted motion vector among the sorted predicted motion vectors in the candidate list using the index pmvIdx obtained by the difference vector obtaining section 205, to output the identified predicted motion vector to the motion vector determining section 208.

<Operations>

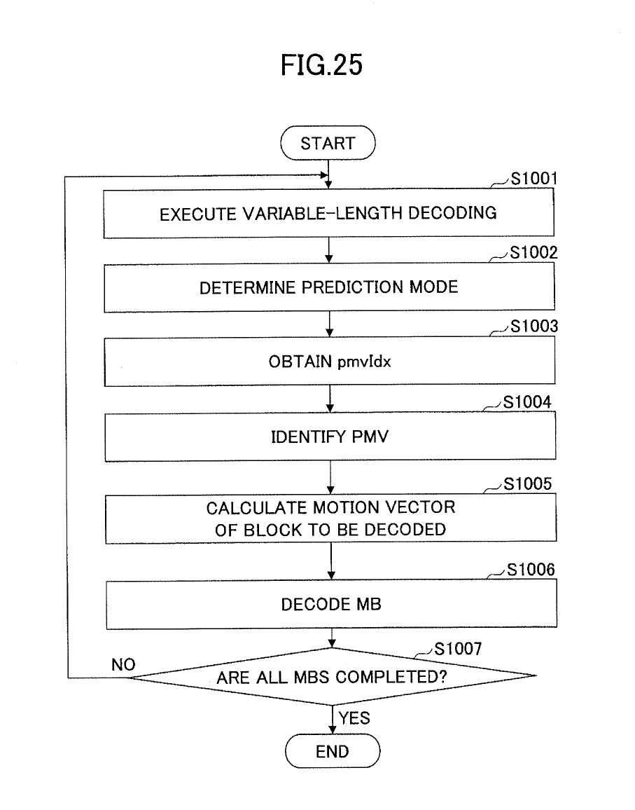

Next, operations of the moving image decoding apparatus will be described according to the eighth embodiment. FIG. 25 is a flowchart illustrating a moving image encoding process according to the eighth embodiment. Steps S1001, S1002, S1006, and S1007 illustrated in FIG. 25 are substantially the same as Steps S201, S202, S208, and S209 illustrated in FIG. 8, respectively, and their description is omitted.

At Step S1003 illustrated in FIG. 25, the difference vector obtaining section 205 obtains the index pmvId of the predicted motion vector from decoded data.

At Step S1004, the predicted motion vector compensation section 601 sorts indices pmvIdx of candidates of the predicted motion vector with the reference destinations of the candidates of the predicted motion vector, the components of the motion vector, and the like. The predicted motion vector compensation section 601 identifies the predicted motion vector among the sorted pmvIdxs.

At Step S1005, the motion vector determining section 208 calculates the motion vector of the block to be decoded using the identified predicted motion vector.

As above, according to the eighth embodiment, it is possible to appropriately decode encoded data with a reduced encoding amount for a motion vector by decoding in the reverse order of the encoding process according to the seventh embodiment.

### Modified Example

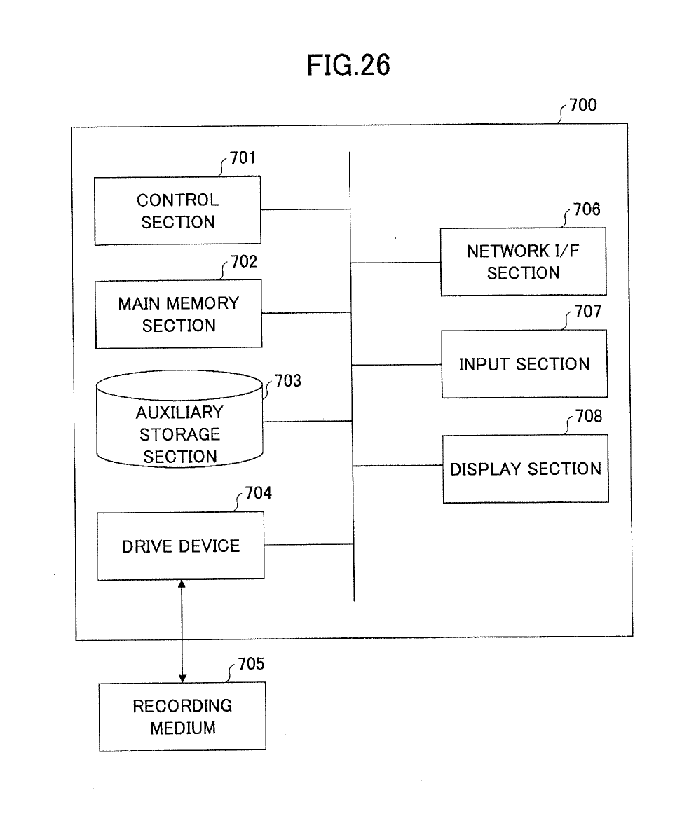

FIG. 26 is a block diagram illustrating an example of a configuration of an image processing apparatus 700. The image processing apparatus 700 is an example of the moving image encoding apparatus or the moving image decoding apparatus described in the embodiments. As illustrated in FIG. 26, the image processing apparatus 700 includes a control section 701, a main memory section 702, an auxiliary storage section 703, a drive device 704, a network I/F section 706, an input section 707, and a display section 708. These configuration elements are connected with each other via a bus to send/receive data.

The control section 701 is a CPU in a computer for controlling devices and for calculating and processing data. The control section 701 is also a processing unit for executing a program stored in the main memory section 702 and the auxiliary storage section 703, receives data from the input section 707 or storage devices, calculates and processes the data to output it to the display section 708, the storage devices, and the like.

The main memory section 702 includes a ROM (Read Only Memory), a RAM (Random Access Memory), and the like, which is a memory device for storing or temporarily holding programs and data executed by the control section 701 such as basic software, namely OS, and application software.

The auxiliary storage section 703 includes an HDD (Hard Disk Drive) and the like, which is a storage device for storing data relevant to the application software.

The drive device 704 reads a program from a recording medium 705, for example, a flexible disk, to install the program into the storage device.

Also, a predetermined program is stored in the recording medium 705, which is installed into the image processing apparatus 700 via the drive device 704. The installed predetermined program can be executed by the image processing apparatus 700.

The network I/F section 706 is an interface between the image processing apparatus 700 and peripheral devices that have communication functions and are connected with a network such as a LAN, a WAN or the like constructed with data transmission lines such as wire/wireless lines.

The input section 707 includes a cursor key, a keyboard provided with keys for entering numerals and other functions, a mouse, a touchpad, and the like for selecting a key on the display screen on the display section 708. The input section 707 is also a user interface for a user to enter an operation command or data to the control section 701.

The display section 708 is configured with a CRT (Cathode Ray Tube) or an LCD (Liquid Crystal Display), on which data input from the control section 701 is displayed. Here, the display section 708 may be provided externally; in that case, the image processing apparatus 700 has a display control section.

In this way, the moving image encoding process or the moving image decoding process described in the embodiments may be implemented as a program executed by a computer. It is possible to have a computer execute the program installed from a server or the like to implement the moving image encoding process or the moving image decoding process described above.

Also, it is possible to implement the moving image encoding process or the moving image decoding process described above by recording the program on the recording medium 705 and having a computer or a portable terminal device read the recording medium 705 on which the program is recorded. Here, various types of recording media 705 can be used including a recording medium that records information optically, electrically, or magnetically such as a CD-ROM, a flexible disk, an optical magnetic disk and the like, and a semi-conductor memory and the like that records information electrically such as a ROM, a flash memory, and the like. Also, it is possible to implement the moving image encoding process or the moving image decoding process described above with the embodiments, which may be implemented on one or multiple integrated circuits.

It is noted that although the above embodiments are described for encoding/decoding methods of two-view stereoscopic video, the methods are applicable to video with views more than two. Basic concepts are the same, and it is obvious that the efficient motion vector encoding/decoding can be executed by considering values in the reference destination picture of a block to be processed and the reference destination picture of predicted motion vectors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A moving image decoding method for decoding encoded data of an image partitioned into a plurality of blocks, comprising:
determining a predicted motion vector corresponding to a motion vector of a block to be decoded by using motion vector information that includes a motion vector of an already-decoded block and reference destination information designating a reference destination of the motion vector of the already-decoded block;
controlling a variable-length decoding process of the motion vector of the block to be decoded using the predicted motion vector depending on whether the reference destination information designating the reference destination of the motion vector designates an inter-view reference image; and
decoding the motion vector of the block to be decoded with the controlled variable-length decoding process.

2. The moving image decoding method as claimed in claim 1, wherein, when controlling the variable-length decoding process of the motion vector, the variable-length decoding process is changed depending on whether both of the reference destination information of the motion vector of the block to be decoded and the reference destination information of the predicted motion vector designate the inter-view reference image.

3. The moving image decoding method as claimed in claim 1, wherein, when controlling the variable-length decoding process of the motion vector, in a case in which the variable-length decoding process is a decoding process corresponding to context-adaptive binary arithmetic coding, a context is changed when both of the reference destination information of the motion vector of the block to be decoded and the reference destination information of the predicted motion vector designate the inter-view reference image.

4. The moving image decoding method as claimed in claim 1, wherein, when controlling the variable-length decoding process of the motion vector, in a case in which the reference destination information of the motion vector of the block to be decoded designates the inter-view reference image, a vertical component of the predicted motion vector is set to zero.

5. The moving image decoding method as claimed in claim 1, wherein, when controlling the variable-length decoding process of the motion vector, in a case in which the reference destination information of the motion vector of the block to be decoded designates the inter-view reference image, a horizontal component of the predicted motion vector is set to a predetermined value.

6. The moving image decoding method as claimed in claim 1,
wherein, when controlling the variable-length decoding process of the motion vector, a decoding process of a difference vector representing a difference between the motion vector and the predicted motion vector is changed, and
wherein the variable-length decoding process decodes the difference vector, and generates the motion vector by adding the difference vector and the predicted motion vector.

7. A moving image encoding method for encoding data of an image partitioned into a plurality of blocks, comprising:
determining a predicted motion vector corresponding to a motion vector of a block to be encoded by using motion vector information that includes a motion vector of an already-encoded block and reference destination information designating a reference destination of the motion vector of the already-encoded block;
controlling a variable-length encoding process of the motion vector of the block to be encoded using the predicted motion vector depending on whether the reference destination information designating the reference destination of the motion vector designates an inter-view reference image; and
encoding the motion vector of the block to be encoded with the controlled variable-length encoding process.

8. The moving image encoding method as claimed in claim 7, wherein, when controlling the variable-length encoding process of the motion vector, the variable-length encoding process is changed depending on whether both of the reference destination information of the motion vector of the block to be encoded and the reference destination information of the predicted motion vector designate the inter-view reference image.

9. A moving image decoding apparatus for decoding encoded data of an image partitioned into a plurality of blocks, comprising:
a storage configured to store motion vector information including a motion vector of an already-decoded block and reference destination information designating a reference destination of the motion vector of the already-decoded block; and
a processor configured to perform a process including
determining a predicted motion vector corresponding to the motion vector of the block to be decoded by using the motion vector information stored in the storage;
controlling a variable-length decoding process of the motion vector using the predicted motion vector depending on whether the reference destination information designating the reference destination of the motion vector designates an inter-view reference image; and
decoding the motion vector of the block to be decoded with the controlled decoding process.

10. The moving image decoding apparatus as claimed in claim 9, wherein the controlling the variable-length decoding process of the motion vector changes the variable-length decoding process depending on whether both of the reference destination information of the motion vector of the block to be decoded and the reference destination information of the predicted motion vector designate the inter-view reference image.

11. The moving image decoding apparatus as claimed in claim 9, wherein, in a case in which the variable-length decoding process is a decoding process corresponding to context-adaptive binary arithmetic coding, the controlling the variable-length decoding process of the motion vector changes a context when both of the reference destination information of the motion vector of the block to be decoded and the reference destination information of the predicted motion vector designate the inter-view reference image.

12. The moving image decoding apparatus as claimed in claim 9, wherein, in a case in which the reference destination information of the motion vector of the block to be decoded designates the inter-view reference image, the controlling the variable-length decoding process of the motion vector sets a vertical component of the predicted motion vector to zero.

13. The moving image decoding apparatus as claimed in claim 9, wherein, in a case in which the reference destination information of the motion vector of the block to be decoded designates the inter-view reference image, the controlling the variable-length decoding process of the motion vector sets a horizontal component of the predicted motion vector to a predetermined value.

14. The moving image decoding apparatus as claimed in claim 9,
wherein the controlling the variable-length decoding process of the motion vector changes a decoding process of a difference vector representing a difference between the motion vector and the predicted motion vector, and
wherein the variable-length decoding process decodes the difference vector, and generates the motion vector by adding the difference vector and the predicted motion vector.

15. A non-transitory computer-readable recording medium having a program stored therein for causing a computer to execute a moving image decoding process for decoding encoded data of an image partitioned into a plurality of blocks, the process comprising:
determining a predicted motion vector corresponding to a motion vector of a block to be decoded by using motion vector information that includes a motion vector of an already-decoded block and reference destination information designating a reference destination of the motion vector of the already-decoded block;
controlling a variable-length decoding process of the motion vector of the block to be decoded using the predicted motion vector depending on whether the reference destination information designating the reference destination of the motion vector designates an inter-view reference image; and
decoding the motion vector of the block to be decoded with the controlled variable-length decoding process.

16. The non-transitory computer-readable recording medium as claimed in claim 15, wherein the controlling the variable-length decoding process of the motion vector changes the variable-length decoding process depending on whether both of the reference destination information of the motion vector of the block to be decoded and the reference destination information of the predicted motion vector designate the inter-view reference image.
